(19) United States
(12) Patent Application Publication
(10) Pub. No.: US 2026/0099206 A1
(43) Pub. Date: Apr. 9, 2026

(54) RING-SHAPED DEVICE

(71) Applicant: CANON KABUSHIKI KAISHA, Tokyo (JP)

(72) Inventor: KOUJI IKEDA, Tokyo (JP)

(21) Appl. No.: 19/405,861

(22) Filed: Dec. 2, 2025

Related U.S. Application Data
(63) Continuation of application No. PCT/JP2024/019604, filed on May 28, 2024.

(30) Foreign Application Priority Data
Jun. 9, 2023 (JP) 2023-095572

(51) Int. Cl. G06F 3/01; G06F 3/033; H01Q 1/27

(52) U.S. Cl. CPC G06F 3/016; G06F 3/014; G06F 3/033; H01Q 1/273; G06F 2203/0331; G06F 2203/0384

(57) ABSTRACT

A ring-shaped device worn on a finger of a user includes annular bodies surrounding a wearing space, a vibrating element provided inside of the annular body, and a control portion that controls the vibrating element. An imaginary line passing through the vibrating element along a vibration axis line of the vibrating element passes through the wearing space.

### CROSS-REFERENCE TO RELATED APPLICATIONS

This application is a Continuation of International Patent Application No. PCT/JP2024/019604, filed May 28, 2024, which claims the benefit of Japanese Patent Application No. 2023-095572, filed Jun. 9, 2023, both of which are hereby incorporated by reference herein in their entirety.

### BACKGROUND

### Field of the Technology

The present disclosure relates to a ring-shaped device used for operating an information processing apparatus.

### Description of the Related Art

Ring-shaped operating devices used while being worn on a finger have emerged as devices for operating information processing apparatuses (WO 2023/286316), and are attracting attention in recent years as an operation and input unit used instead of conventional mice, keyboards, touchpads, and the like.

From the perspective of reducing the burden on the finger, such a ring-shaped device is preferably made as light as possible. The fit when worn on the finger is also important. This refers to whether the device can be kept in a stable posture when worn on the finger, whether a user must put their hand or finger into an unnatural position to put the device on, whether the device causes discomfort, and the like. Furthermore, whether various operations can be performed easily while wearing the device on the finger, i.e., the usability, is also important.

Such a ring-shaped device may incorporate a vibrating element as what is known as a “haptic device”. Of the device components, the vibrating element is a component that consumes a large amount of power, and it is therefore desirable for the vibrating element to vibrate efficiently, using as little power as possible. Installing a high-capacity battery is particularly difficult in a ring-shaped device, and it is therefore necessary to efficiently transmit vibrations using a small amount of power.

### SUMMARY

The present disclosure is directed to provide a technique that enables a user of a ring-shaped device including a vibrating element to more efficiently and effectively sense vibrations.

An aspect of the present disclosure provides a ring-shaped device is a ring-shaped device worn on a finger of a user, the ring-shaped device including:
an annular body surrounding a wearing space;
a vibrating element provided inside of the annular body; and
a control portion that controls the vibrating element,
wherein an imaginary line passing through the vibrating element along a vibration axis line of the vibrating element passes through the wearing space.

Features of the present disclosure will become apparent from the following description of embodiments with reference to the attached drawings.

### BRIEF DESCRIPTION OF THE DRAWINGS

FIG. 1A is a front view of the ring-shaped device 1 seen along an insertion direction in which a finger is inserted into the ring-shaped device 1 according to Embodiment 1 of the present disclosure.

FIG. 1B is a diagram seen from arrow A in FIG. 1A, and is a top view illustrating the configuration of an operated surface of the ring-shaped device 1 according to Embodiment 1 of the present disclosure.

FIG. 1C is a diagram seen from arrow B in FIG. 1A, and is a side view of the ring-shaped device 1 according to Embodiment 1 of the present disclosure.

FIG. 2A is an overall explanatory diagram of an information processing system 100 in a state where three virtual objects O1 to O3 are arranged side by side in front of the user wearing the HMD 101.

FIG. 2B is an overall explanatory diagram of an information processing system 100 in a state in which the user operates the ring-shaped device 1 to select the virtual object O2 from among the three virtual objects O1 to O3.

FIG. 3 is an explanatory diagram illustrating a control configuration of the information processing system 100.

FIG. 4A is a schematic diagram illustrating a first wearing state, which is an example of a wearing state when the ring-shaped device 1 is used.

FIG. 4B is a schematic diagram illustrating a second wearing state, which is another example of a wearing state when the ring-shaped device 1 is used.

FIG. 4C is a schematic diagram illustrating a third wearing state, which is an example of a wearing state when the ring-shaped device 1 is not in use.

FIG. 5A is a schematic diagram illustrating changes in the postures of a first arm portion 3 and a second arm portion 4 in a case where the ring-shaped device 1 is worn on a finger F2 having a second thickness greater than a first thickness.

FIG. 5B is a schematic diagram illustrating changes in the postures of the first arm portion 3 and the second arm portion 4 in a case where the ring-shaped device 1 is worn on a finger F1 having the first thickness.

FIG. 5C is a schematic diagram illustrating changes in the postures of the first arm portion 3 and the second arm portion 4 in a case where the ring-shaped device 1 is worn on a finger F3 having a third thickness greater than the second thickness.

FIG. 6A is a bottom view of the ring-shaped device 1 seen in the direction opposite from the arrow A in FIGS. 1A to 1C.

FIG. 6B is a bottom view of the ring-shaped device 1 according to a variation in which the width of the first arm portion 3 has been changed from that in the ring-shaped device 1 illustrated in FIG. 6A.

FIG. 7A is a schematic diagram of the first arm portion 3.

FIG. 7B is a cross-sectional view along arrow C in FIG. 7A.

FIG. 8 is a schematic diagram illustrating the configuration of the ring-shaped device 1.

FIG. 9 is a schematic diagram illustrating the configuration of the ring-shaped device 1.

FIG. 10 is a schematic diagram illustrating a variation on the configuration of the ring-shaped device 1.

FIG. 11 is a schematic diagram illustrating a variation on the configuration of the ring-shaped device 1.

FIG. 12 is a schematic diagram illustrating a variation on the configuration of the ring-shaped device 1.

FIG. 13 is a schematic diagram illustrating the configuration of the ring-shaped device 1.

FIG. 14 is a schematic front view illustrating the configuration of the ring-shaped device 1.

FIG. 15A is a schematic front view of a ring-shaped device 1b according to Comparative Example 1.

FIG. 15B is a schematic side view of a ring-shaped device 1c according to Comparative Example 2.

FIG. 16A a schematic cross-sectional view of the area around the vibrating element 8 in the ring-shaped device 1 according to the present embodiment.

FIG. 16B is a schematic cross-sectional view seen from arrow D in FIG. 16A.

FIG. 16C is a schematic partial cross-sectional view of the ring-shaped device 1 according to the present embodiment, illustrating a state where the power source 11 has expanded.

FIG. 17 is a schematic side view illustrating the configuration of the ring-shaped device 1.

FIG. 18 is a schematic diagram illustrating the configuration of an operated surface of the ring-shaped device 1.

FIG. 19 is a schematic cross-sectional view seen along arrow E in FIG. 18.

FIG. 20A is a schematic cross-sectional view seen along arrow F in FIG. 18.

FIG. 20B is a schematic cross-sectional view seen along arrow F in FIG. 18.

FIG. 21 is a schematic diagram illustrating the configuration of an operated surface of the ring-shaped device 1.

FIG. 22 is a schematic front view of a ring-shaped device 1d according to a variation.

FIG. 23A is a schematic front view of the ring-shaped device 1 according to the present embodiment, illustrating a state where the user is pressing the button switches 6R and 6L with their finger FO.

FIG. 23B is a schematic front view of the ring-shaped device 1 according to the present embodiment, illustrating a state where the user is pressing the touch sensor 5 with their finger FO.

FIG. 24A is a schematic front view of a ring-shaped device 1e according to Comparative Example 3, illustrating a state where the user is pressing the button switches 6R and 6L with their finger FO.

FIG. 24B is a schematic front view of the ring-shaped device 1e according to Comparative Example 3, illustrating a state where the user is pressing the touch sensor 5 with their finger FO.

FIG. 25A is a schematic front view of a ring-shaped device 1f according to Comparative Example 4, illustrating a state where the user is pressing the button switches 6R and 6L with their finger FO.

FIG. 25B is a schematic front view of the ring-shaped device 1f according to Comparative Example 4, illustrating a state where the user is pressing the touch sensor 5 with their finger FO.

FIG. 26A is a schematic diagram illustrating changes in the postures of the first arm portion 3b and the second arm portion 4b in a case where the ring-shaped device 1 is worn on a finger F2.

FIG. 26B is a schematic diagram illustrating changes in the postures of the first arm portion 3 and the second arm portion 4 in a case where the ring-shaped device 1 is worn on a finger F1.

FIG. 26C is a schematic diagram illustrating changes in the postures of the first arm portion 3 and the second arm portion 4 in a case where the ring-shaped device 1 is worn on a finger F3.

FIG. 27A is a bottom view of a ring-shaped device 1g in a case where the first arm portion 3b and the second arm portion 4b are configured having shapes that are generally symmetrical in the insertion direction ID.

FIG. 27B is a bottom view of a ring-shaped device 1g in a case where a first arm portion 3c and a second arm portion 4c may be given different size widths in the insertion direction ID.

FIG. 28 is a bottom view of the ring-shaped device 1g.

### DESCRIPTION OF THE EMBODIMENTS

In the following examples, embodiments of the present disclosure will be described by way of example. However, the configurations disclosed in the following embodiments, for example, the function, material, shape, and relative arrangement of the components illustrate examples of aspects related to the aspects, and are not intended to limit the aspects to the configurations disclosed in these embodiments. Also, the problems or effects achieved by the arrangements disclosed in the following examples or from the disclosed arrangements are not intended to limit the scope of the aspects.

### Embodiment 1

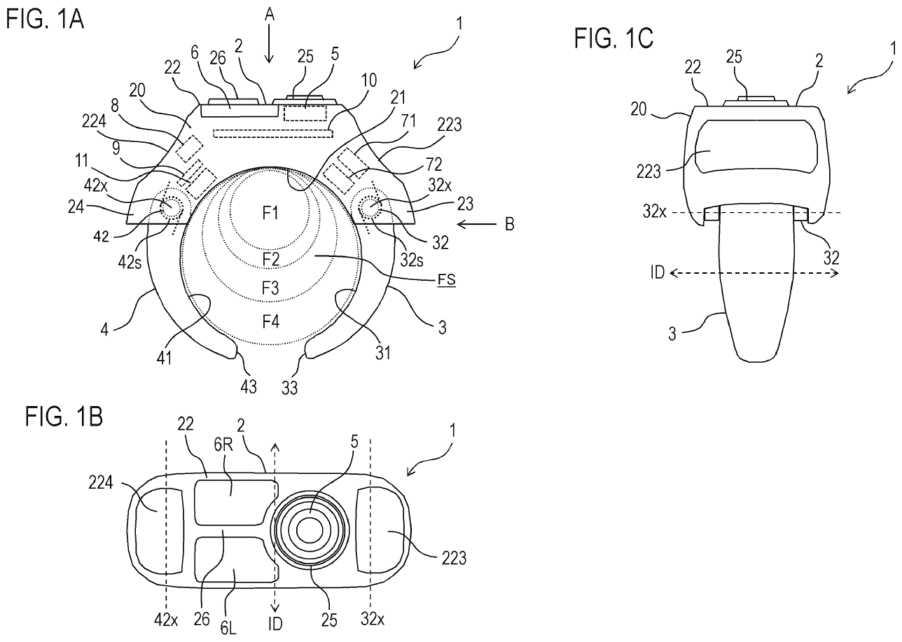

A ring-shaped device 1 according to Embodiment 1 of the present disclosure will be described with reference to FIGS. 1A to 25B.

### Overview of Ring-Shaped Device

FIGS. 1A to 1C are schematic diagrams illustrating the configuration of the ring-shaped device 1 according to Embodiment 1 of the present disclosure. FIG. 1A is a front view of the ring-shaped device 1 seen along an insertion direction in which a finger is inserted into the ring-shaped device 1. FIG. 1B is a diagram seen from arrow A in FIG. 1A, and is a top view illustrating the configuration of an operated surface of the ring-shaped device 1. FIG. 1C is a diagram seen from arrow B in FIG. 1A, and is a side view of the ring-shaped device 1.

As illustrated in FIG. 1A, the ring-shaped device 1 according to the present embodiment generally has a substantially annular external shape, and is configured such that a user can insert their finger F into an opening in the center thereof. More specifically, the ring-shaped device 1 includes a main body 2, a first arm portion 3, and a second arm portion 4, which are connected in an annular shape to form a wearing space FS into which the user can insert their finger F (configuring an annular body surrounding the wearing space FS).

The term “annular” herein is not limited solely to an annular configuration that completely encloses the outer circumference of the wearing space FS, and also includes shape configurations that are partially interrupted and discontinuous but which overall have a substantially annular form, such as a substantially C-shaped configuration.

The main body 2 has a substantially arc-shaped outer casing 20, and the outer casing 20 has an arc-shaped concave inner surface 21 that forms the wearing space FS and an outer surface 22 on the side opposite from that on which the inner surface 21 is located.

The first arm portion 3 is connected to a first end portion 23, which is one end of the main body 2 in the direction surrounding the wearing space FS, and extends in what is substantially an arc from the first end portion 23 of the main body 2 in one direction (a first direction) in the direction surrounding wearing space FS. The first arm portion 3 has a concave arc-shaped inner surface 31 that forms the wearing space FS, and the inner surface 31 opposes the inner surface 21 of the main body 2 with the wearing space FS therebetween. The first arm portion 3 is rotatably attached to the first end portion 23 of the main body 2 such that a gap over which the inner surface 31 and the inner surface 21 of the main body 2 oppose each other is variable.

The second arm portion 4 is connected to a second end portion 24, which is the other end of the main body 2 in the direction surrounding the wearing space FS, and extends in what is substantially an arc from the second end portion 24 of the main body 2 in the other direction (a second direction) in the direction surrounding the wearing space FS. The second arm portion 4 has a concave arc-shaped inner surface 41 that forms the wearing space FS, and the inner surface 41 opposes the inner surface 21 of the main body 2 with the wearing space FS therebetween. The second arm portion 4 is rotatably attached to the second end portion 24 of the main body 2 such that a gap over which the inner surface 41 and the inner surface 21 of the main body 2 oppose each other is variable.

The first arm portion 3 is biased by a torsion coil spring 32s as a first biasing member, and the second arm portion 4 is biased by a torsion coil spring 42s as a second biasing member, each spring biasing the corresponding member in a direction that closes the wearing space FS, i.e., in the direction of narrowing the gap with the inner surface 21 of the main body 2. Accordingly, the first arm portion 3 and the second arm portion 4 can each follow the thickness (diameter) of the finger F inserted into the wearing space FS and rotate relative to the main body 2. In other words, depending on the thickness (diameter) of the finger F inserted into the wearing space FS, the gaps over which the first arm portion 3 and the second arm portion 4 oppose the inner surface 21 of the main body 2 change, making it possible to change the width of the wearing space FS.

Here, a rotation axis line 32x of a rotation shaft 32 of the first arm portion 3 relative to the main body 2, and a rotation axis line 42x of a rotation shaft 42 of the second arm portion 4 relative to the main body 2, are in a direction along an insertion direction ID in which the finger F is inserted into the wearing space FS. Although the rotation axis line 32x, the rotation axis line 42x, and the insertion direction ID are configured parallel to each other in the present embodiment, the configuration is not limited thereto. The rotation axis line 32x, the rotation axis line 42x, and the insertion direction ID may be configured inclined relative to each other within a predetermined range, rather than being parallel, as long as the same effect as that of the present embodiment is achieved, i.e., as long as the width of the wearing space FS can be changed without affecting the wearability and usability.

### Configuration of Main Body

In the main body 2, a touch sensor 5 and a button switch 6 are incorporated into the outer surface 22 of the outer casing 20. The touch sensor 5 and the button switch 6 are disposed aligned in the direction surrounding the wearing space FS. As illustrated in FIG. 1B, the button switch 6 is disposed aligned in a shape symmetrical to the insertion direction ID of the finger F. A first finger placement portion 223 and a second finger placement portion 224 are provided on corresponding sides of an operation portion, in which the touch sensor 5, the button switch 6, and the like are disposed on the outer surface 22, in the stated surrounding direction. The first finger placement portion 223 and the second finger placement portion 224 are formed in a concave shape so that, for example, the fingers adjacent to the finger inserted into the wearing space FS can be rested thereon. In addition, an inertial sensor 71, a geomagnetic sensor 72, a vibrating element 8, a communication portion 9, a control portion 10, a power source 11, and the like are provided in the interior of the main body 2 (the interior of the outer casing 20).

The touch sensor 5 and the button switch 6 will be described in detail later.

The inertial sensor 71 includes an accelerometer for detecting the position and velocity of the ring-shaped device 1 provided with the inertial sensor 71, a gyro sensor (an angular velocity sensor) for detecting the posture and orientation of the ring-shaped device 1, and the like. Data on the Earth's magnetic force, detected by the geomagnetic sensor 72, is used to correct the detection data from the inertial sensor 71.

The vibrating element 8 is used to cause the ring-shaped device 1 to vibrate to provide vibrations to the user's finger F as tactile information. The communication portion 9 is constituted by a wireless module, a wireless antenna, and the like, for example, and can establish a communication connection with an external device through wireless communication such as Wi-Fi (registered trademark) or Bluetooth (registered trademark).

The control portion 10 includes, for example, a CPU serving as a computation processing portion, a ROM and RAM serving as storage portions for storing programs and computation parameters, and the like, and controls the overall operations of the ring-shaped device 1. The power source 11 supplies power to each part of the ring-shaped device 1.

### Overview of Information Processing System

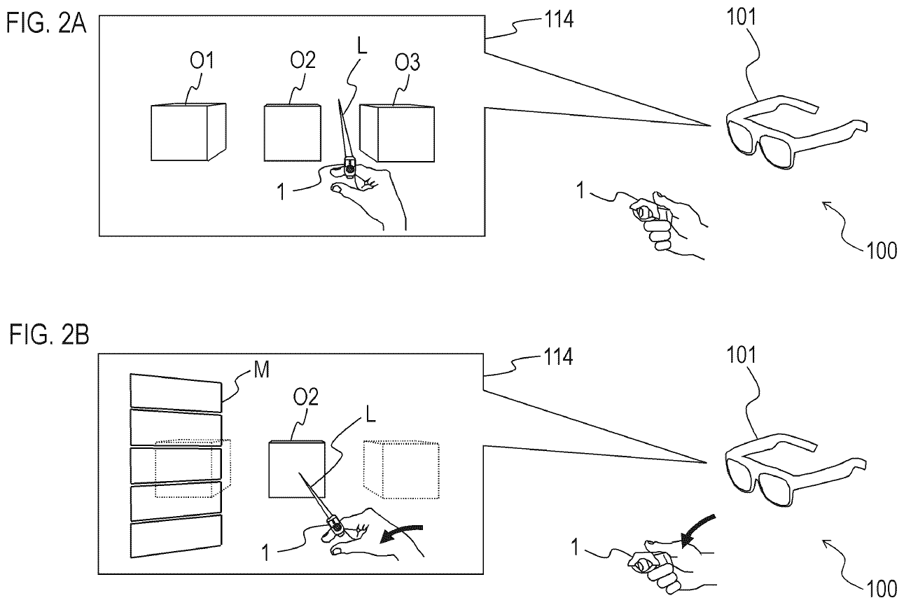

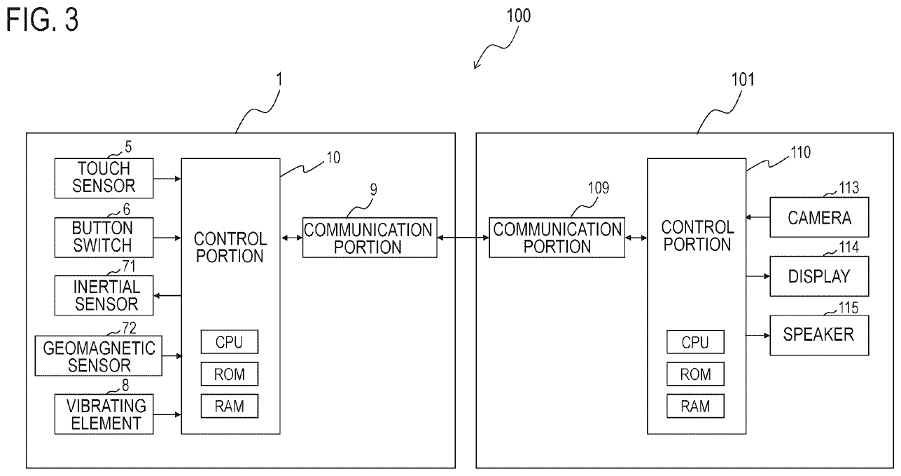

An overview of an information processing system 100 in which the ring-shaped device 1 according to the present embodiment is used will be described with reference to FIGS. 2A, 2B, and 3.

The information processing system 100 illustrated in FIGS. 2A, 2B, and 3 is a system that provides what is known as a mixed reality (MR) space to a user using a head-mounted display (HMD) 101. The HMD 101 includes a camera 113 for capturing a space which the user wearing the HMD 101 faces, and a display 114 for displaying video so as to be visible to the user wearing the HMD 101. A control portion 110 includes, for example, a CPU serving as a computation processing portion, a ROM and RAM serving as storage portions for storing programs and computation parameters, and the like, and controls the overall operations of the HMD 101. Video in which images such as virtual objects which do not have corresponding real objects, generated by signal processing in the HMD 101, are superimposed on a real space captured by the camera 113, is displayed on the display 114.

The ring-shaped device 1 and the HMD 101 are connected by wired or wireless communication between the communication portion 9 and a communication portion 109, and can exchange data with each other.

The user can use the ring-shaped device 1 to make various input operations on the virtual object and the like displayed on the display 114. For example, various input operations can be made by changing the orientation of the ring-shaped device 1, operating the touch sensor 5 and the button switch 6 provided in the operation portion of the ring-shaped device 1, or combining such operations in various ways.

In the example illustrated in FIG. 2A, three virtual objects O1 to O3 are arranged side by side in front of the user wearing the HMD 101. A virtual light ray L is displayed on the display 114 extending from the ring-shaped device 1 worn by the user on their finger, forward in a direction corresponding to the direction in which the ring-shaped device 1 is facing. The virtual light ray L is what is known as a laser pointer-type user interface.

FIG. 2B illustrates a state in which the user operates the ring-shaped device 1 to select the virtual object O2 from among the three virtual objects O1 to O3. The user can perform an operation to select the virtual object O2 by changing the position and orientation of the ring-shaped device 1 such that the virtual light ray L hits the virtual object O2 and tapping the touch sensor 5 of the operation portion, for example. When the selection operation of the virtual object O2 is made, various information pertaining to the virtual object O2 and a menu for performing various input operations on the virtual object O2 are displayed as a virtual object M next to the virtual object O2. Various input operations can also be made on the virtual object M using the ring-shaped device 1.

Note that in a system that can recognize a real three-dimensional structure from an image captured by the camera 113, virtual input operations can be made on the recognized three-dimensional structure using the ring-shaped device 1.

In addition, sound corresponding to the operating state of the ring-shaped device 1 and a state in the MR space displayed on the display 114 is output from a speaker 115, and audio information is provided to the user along with the visual information. Furthermore, the vibrating element 8 generates vibrations corresponding to the operating state of the ring-shaped device 1 and the state in the MR space displayed on a display 114, and transmits the vibrations to the finger or hand on which the ring-shaped device 1 is worn. In other words, tactile information corresponding to the visual information and the audio information is provided to the user.

Although the information processing system 100 described above is a system using what is known as a video see-through method here, the ring-shaped device 1 according to the present embodiment can be used even in a system using an optical see-through method. In other words, this is a system configured to project the real space directly into the user's eyes through lenses provided in the HMD 101 and display virtual objects and the like on the lenses, rather than displaying images on the display 114. Alternatively, the ring-shaped device 1 according to the present embodiment can be used even in a system that allows a user to view a virtual object by projecting video onto the retina of the user.

In addition, the information processing system 100 described above can be used to display, on the display 114, a virtual reality (VR) space generated solely by signal processing within the HMD 101, without utilizing video captured by the camera 113. In other words, the system may also be used as a system for providing a virtual reality (VR) space to the user, and various input operations can be made using the ring-shaped device 1 of the present embodiment even within such a VR space.

### Details of Ring-Shaped Device (Configuration of Operation Portion)

The touch sensor 5 detects contact from the finger F and sends an input signal to the control portion 10, and is configured such that various types of input signals can be sent to the control portion 10 by changing the manner in which the finger F makes contact. Specifically, a tap operation where the finger F is brought into contact with the touch sensor 5 in a manner resembling a quick tap and then released, a swiping operation where the finger F is brought into contact with the touch sensor 5 so as to slide and change the position where the finger F makes contact with the touch sensor 5, and the like can be given as examples. Such various input operations make it possible to perform an operation of selecting a virtual object, a scrolling operation, and the like. An operation in which a predetermined state is maintained only while the finger F remains touching the touch sensor 5 can also be performed. For example, an operation can be performed such that the virtual light ray L remains emitted only while the finger F remains in contact with the touch sensor 5, and the virtual light ray L is not emitted when the finger F is removed from the touch sensor 5. Alternatively, an operation can be performed such that a virtual object remains selected while the finger F remains in contact with the touch sensor 5, and the virtual object is deselected when the finger F is removed from the touch sensor 5.

A pair of button switches 6L and 6R may be used, for example, when performing an alternative selection operation or an opposite selection operation. For example, the configuration may be such that while the virtual object O2 is selected as illustrated in FIG. 2B, when the button switch 6L is pressed, the selection target is changed to the virtual object O1 to the left, and when the button switch 6R is pressed, the selection target is changed to the virtual object O3 to the right.

### Details of Ring-Shaped Device (How to Wear)

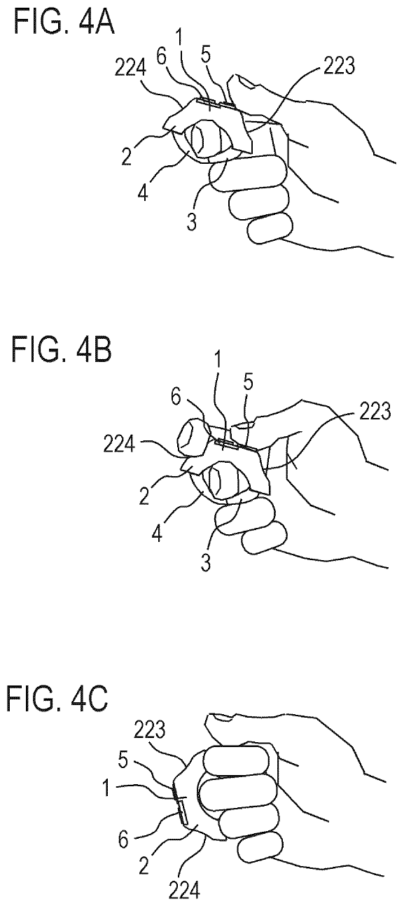

FIG. 4A is a schematic diagram illustrating a first wearing state, which is an example of a wearing state when the ring-shaped device 1 is used. FIG. 4B is a schematic diagram illustrating a second wearing state, which is another example of a wearing state when the ring-shaped device 1 is used. FIG. 4C is a schematic diagram illustrating a third wearing state, which is an example of a wearing state when the ring-shaped device 1 is not in use. Note that the wearing states illustrated here are merely examples, and the wearing states of the ring-shaped device 1 according to the present embodiment are not limited to the following.

The first wearing state illustrated in FIG. 4A is a wearing state when the ring-shaped device 1 is worn on the index finger. In other words, this is a wearing state in which the index finger is inserted into the wearing space FS and various operations are made using the thumb. In this wearing state, a posture can be taken in which the thumb is placed on the first finger placement portion 223.

The second wearing state illustrated in FIG. 4B is a wearing state when the ring-shaped device 1 is worn on the middle finger. In other words, this is a wearing state in which the middle finger is inserted into the wearing space FS and various operations are made mainly using the thumb. In this wearing state, a posture can be taken in which the thumb is placed on the first finger placement portion 223 and in which the index finger is placed on the second finger placement portion 224.

The third wearing state illustrated in FIG. 4C is, for example, a wearing state used when the user will not use the ring-shaped device 1 for the time being but wishes to keep holding the ring-shaped device 1. As illustrated in FIG. 4C, the orientation of the ring-shaped device 1 is changed from the wearing states illustrated in FIGS. 4A and 4B, with the ring-shaped device 1 being gripped and held. The ring-shaped device 1 is configured such that the volume of the main body 2 is relatively greater than the first arm portion 3 and the second arm portion 4. In the third wearing state, the first arm portion 3 and the second arm portion 4 are gripped in the palm of the hand. On the other hand, in the first and second wearing states, a part of the main body 2 is gripped in the palm of the hand. In other words, the volume of the ring-shaped device 1 in the palm of the hand is lower in the third wearing state than in the first and second wearing states, which makes it easier to grip and hold with the finger and suppresses situations where the ring-shaped device 1 gets in the way of tasks or the like.

### Details of Ring-Shaped Device (Configuration of Arm Portions)

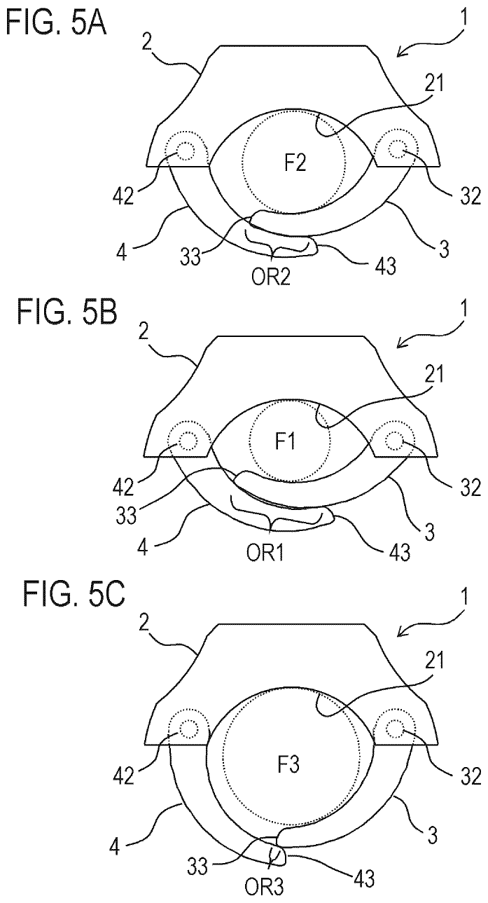

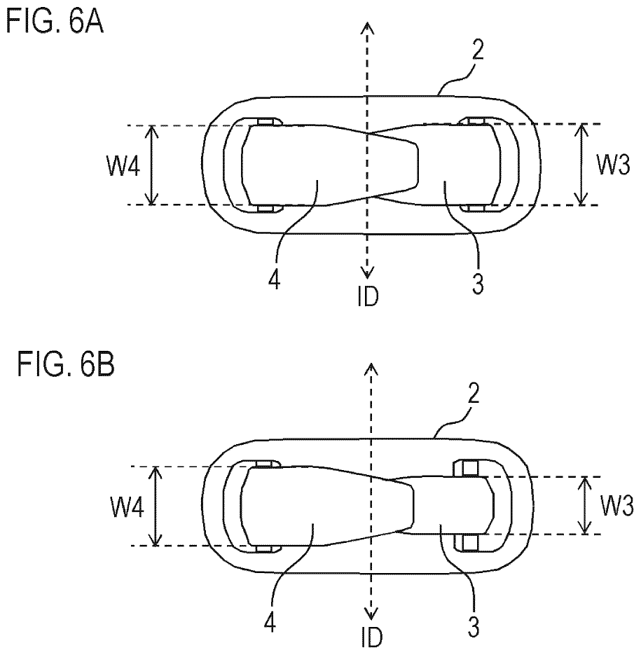

The configurations of the first arm portion 3 and the second arm portion 4 of the ring-shaped device 1 will be described with reference to FIGS. 5A to 5C, 6A, and 6B. FIGS. 5A to 5C are schematic diagrams illustrating changes in the postures of the first arm portion 3 and the second arm portion 4 due to differences in the thickness of the finger F. Cases where the ring-shaped device 1 is worn on a finger F1 having a first thickness (FIG. 5B), a finger F2 having a second thickness greater than the first thickness (FIG. 5A), and a finger F3 having a third thickness greater than the second thickness (FIG. 5C) will be described here. FIG. 6A is a bottom view of the ring-shaped device 1 seen in the direction opposite from the arrow A in FIGS. 1A to 1C. FIG. 6B is a diagram similar to FIG. 6A, and is a bottom view of the ring-shaped device 1 according to a variation in which the width of the first arm portion 3 has been changed from that in the ring-shaped device 1 illustrated in FIG. 6A.

As illustrated in FIG. 6A, the first arm portion 3 and the second arm portion 4 are disposed such that the positions thereof in the insertion direction ID of the finger F relative to the wearing space FS overlap each other. In addition, the lengths of the first arm portion 3 and the second arm portion 4 from the main body 2, in the direction surrounding the wearing space FS, are such that a region on each tip side thereof interferes with the other depending on the thickness of the finger F on which the ring-shaped device 1 is worn. In other words, the configuration is such that the tip of one of the first arm portion 3 or the second arm portion 4 when the arm portion are closest to the inner surface 21 of the main body 2 is positioned closer to the rotation axis line of the other arm portion than the tip of the other arm portion when the other arm portion is closest to the inner surface 21.

As illustrated in FIG. 1A, when worn on a finger F4 having a fourth thickness that is thicker than the third thickness, the first arm portion 3 and the second arm portion 4 are at a large angle relative to the main body 2, and therefore do not interfere with each other. However, as illustrated in FIGS. 5A to 5C, when the wearing space FS corresponding to the fingers F1 to F3 is formed, the regions on the tip sides of the first arm portion 3 and the second arm portion 4 interfere with each other. Accordingly, for the fingers F1 to F3, both the first arm portion 3 and the second arm portion 4 cannot be in contact at the same time, and one arm portion contacts the fingers F1 to F3, while the other arm portion biases (supports from the back surface) the other arm portion against the fingers F1 to F3. In other words, the region including at least the tip of the other arm portion when the other arm portion is closest to the inner surface 21 of the main body 2 is positioned further outward, with respect to the wearing space FS, than the one arm portion when the one arm portion is closest to the inner surface 21.

The smaller the thickness of the finger F is, the larger the space between finger F and the wearing space FS becomes, and thus a fit must be formed with a wider gap between the wearing finger F and the finger F adjacent thereto. In other words, there is a concern that as the thickness of the finger F decreases, the fit of the ring-shaped device 1 relative to the finger F will become more unstable.

Here, with the ring-shaped device according to the present embodiment, the configuration is such that the one arm portion in contact with the finger F is supported by the other arm portion from behind. Furthermore, the configuration is such that the region where the other arm portion contacts the one arm portion, i.e., a region OR where the one arm portion and the other arm portion overlap each other when viewed in a direction perpendicular to the rotation axis line of the one arm portion or the rotation axis line of the other arm portion, becomes wider as the finger F becomes thinner. As illustrated in FIGS. 5A to 5C, from the finger F3 to the finger F1, the contact region between the one arm portion and the other arm portion is wider in the order of region OR3, OR2, and OR1. As the contact region becomes broader, the surface area affected by the biasing force received by the one arm portion from the other arm portion broadens as well, and the force holding the finger F between the one arm portion and the inner surface 21 of the main body 2 increases, which stabilizes the wearing state.

This configuration makes it possible to suppress instability in the fit of the ring-shaped device 1 on the finger F when the thickness of the finger F decreases, by expanding the contact region between the first arm portion 3 and the second arm portion 4.

In this manner, the wearing space FS can be changed to sizes that accommodate the fingers F1 to F4 of various sizes (diameters), while at the same time varying the holding force applied to finger F according to the thickness of the finger F. This enables the main body 2, first arm portion 3, and second arm portion 4 to securely wrap around the outer circumference of the finger F, even when the size of the inserted finger F varies. In other words, regardless of differences in the size of the finger F inserted into the wearing space FS, the ring-shaped device 1 is worn and held on the user's finger F in a stable posture.

Although the present embodiment describes a configuration where the first arm portion 3 is located further inward than the second arm portion 4 to directly contact the finger F, with the second arm portion 4 supporting the first arm portion 3 from behind, the reverse configuration is also possible. In other words, the configuration may be such that the second arm portion 4 is located further inward than the first arm portion 3 to directly contact the finger F, with the first arm portion 3 supporting the second arm portion 4 from behind.

The biasing force (spring constants of the torsion coil springs) applied to the first arm portion 3 and the second arm portion 4 is preferably set to a magnitude at which no slippage occurs between the finger F and the ring-shaped device 1, for example, in users having a slender finger F. For example, the spring constant of the torsion coil spring may be set by adjusting the number of coils to generate a biasing force of at least 10 N*mm. Conversely, for a user having a thicker finger F, excessive force may cause pain during wear, and it is therefore preferable to set the biasing force to a level that does not place an excessive load on the finger F. For example, the spring constant of the torsion coil spring may be set by adjusting the number of coils to suppress the biasing force to not more than 45 N*mm. The biasing force is preferably set to be at least 15 N*mm and not more than 30 N*mm, although this does depend on the device configuration. The range between the lower limit and upper limit of the biasing force may be determined, for example, through experiments or the like, and the spring constants of a torsion coil spring 32a and a torsion coil spring 42a may be set as appropriate.

The biasing force that biases the first arm portion 3 (the spring constant of the torsion coil spring 32a) and the biasing force that biases the second arm portion 4 (the spring constant of the torsion coil spring 42a) may be set to about the same magnitude. However, the configuration is not limited thereto, and for example, if the inner arm portion and the outer arm portion are set in advance with respect to the wearing space FS, the biasing force acting on the inner arm portion and the biasing force acting on the outer arm portion may be made different to increase the stability of the fit.

For example, the arm portion, of the first arm portion 3 and the second arm portion 4, which is on the outer side with respect to the wearing space FS may be wider in the insertion direction ID than the arm portion on the inner side, and the number of coils in the torsion coil spring may be increased relatively by a corresponding amount to make the biasing force stronger than that of the arm portion on the inner side. Alternatively, the inner diameter of the inner surface of the arm portion on the outer side may be greater than the inner diameter of the inner surface of the arm portion on the inner side, without making the spring constants different.

In the present embodiment, the width of the wearing space FS is configured such that when viewed in the insertion direction ID, an imaginary circle having a diameter dimension in a predetermined range (i.e., a finger having a thickness corresponding to the imaginary circle) fits therein. Specifically, the width is one at which imaginary circles ranging from a diameter of 12.8 mm (corresponding to the thickness of the finger F1) to a diameter of 25.4 mm (corresponding to the thickness of the finger F4) fit, i.e., a width of at least 12.8 mm and not more than 25.4 mm. As illustrated in FIG. 1A, the reference for changes in the size of the imaginary circle is the deepest part of the concave arc-shaped (concave curved surface-shaped) inner surface 21 of the main body 2. In other words, imaginary circles of various sizes are positioned to pass through the point of the deepest part, and the spatial region corresponding to the size of each imaginary circle serves as the reference for measuring the width of the wearing space FS.

As illustrated in FIG. 6B, the width of the inner arm portion contacting the finger F in the insertion direction ID in which the finger F is inserted into the wearing space FS may be made narrower than the width of the outer arm portion. For example, as illustrated in FIG. 4C, the ring-shaped device 1 can be held by changing the orientation thereof. In this wearing state, the side of the finger F facing the arm portion is the inner side (palm side) of the finger F, and is the concave side that is recessed when the joint of the finger F is bent. In the present embodiment, a width W3 of the first arm portion 3, which is the inner arm portion in contact with the finger F, in the insertion direction ID, is made narrower than a width W4 of the second arm portion 4, which is the outer arm portion distanced from the finger F, in the same direction, which makes it easier to bend the finger F. This makes it easier to adopt a posture where the ring-shaped device 1 is held by bending the finger, and thus when, for example, performing other tasks while holding the ring-shaped device 1, interference with those tasks is suppressed, and an improvement in the efficiency of those tasks can be expected. Furthermore, the steps required to put on and take off the ring-shaped device 1 can be reduced, which makes it possible to improve the efficiency of the series of actions.

Furthermore, each of the first arm portion 3 and the second arm portion 4 is configured such that the width thereof in the insertion direction ID gradually narrows with proximity to the tips thereof. Here, the width of the tip surface of the arm portion on the inner side with respect to the wearing space FS in the insertion direction ID is preferably not more than 20 mm, or not more than the width of the main body 2 in the insertion direction ID. More preferably, this width being not more than 8 mm is more suitable for accommodating the first arm portion 3 and the second arm portion 4 between the first and second joints of the finger F. Alternatively, the configuration may be such that the width of the inner arm portion in the insertion direction ID in the region where the first arm portion 3 and the second arm portion 4 overlap with each other falls within the stated range.

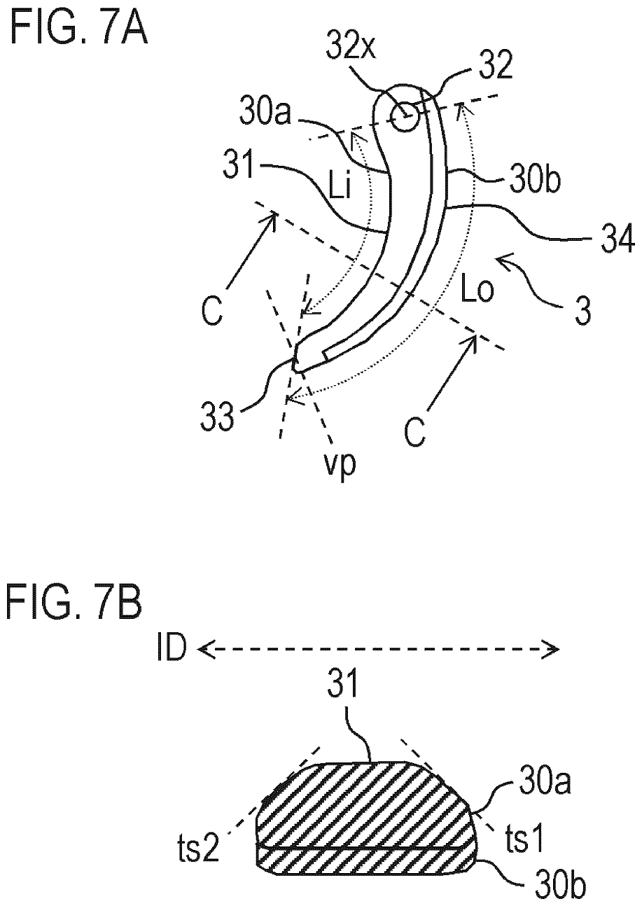

FIG. 7A is a schematic diagram of the first arm portion 3, and FIG. 7B is a cross-sectional view along arrow C in FIG. 7A. Here, only the first arm portion 3 is illustrated, but the second arm portion 4 has a similar configuration and will therefore not be described.

The inner surface 31 is the part of the first arm portion 3 that contacts the finger F in particular, and it is preferable that the surface thereof in particular be configured to be smooth. For example, as illustrated in FIGS. 7A and 7B, the first arm portion 3 may be formed by two members, namely a first member 30a on the inner surface 31 side and a second member 30b on an outer surface 34 side opposite therefrom. According to this configuration, when manufacturing the first arm portion 3 by combining a plurality of members, it is possible to position a parting line between the first member 30a and the second member 30b away from the inner surface 31, which makes it possible to form the inner surface 31 smoothly. Furthermore, it is preferable to position the parting line between the first member 30a and the second member 30b as close as possible to the outer surface 34 to more effectively suppress snagging on the finger F. The inner surface 31 being a smooth concave curved surface suppresses situations where the finger F snags during insertion, and also makes cleaning easier.

Furthermore, as illustrated in FIG. 7A, a tip surface 33 (a first tip surface) of the first arm portion 3 is preferably configured having a tapered surface shape to suppress snagging on the finger F when the finger F and the ring-shaped device 1 rotate relative to each other and the like. In other words, the tip surface 33 of the first arm portion 3 has an inner distance (a first inner distance) Li, from the rotation axis line (a first rotation axis line) 32x of the first arm portion 3 on the inner surface (a first inner surface) 31 to the tip surface 33. There is also an outer distance (first outer distance) Lo from the rotation axis line 32x on the outer surface (first outer surface) 34 to the tip surface 33. The tip surface 33 is inclined relative to an imaginary plane vp perpendicular to the direction in which the first arm portion 3 extends, such that the inner distance Li is shorter than the outer distance Lo.

Furthermore, as illustrated in the cross-section in FIG. 7B (the cross-section along arrow C in FIG. 7A), the inner surface 31 is configured such that respective sides thereof in the insertion direction ID form tapered surfaces ts1 and ts2 that are symmetrically inclined relative to the insertion direction ID. Through such a configuration, snagging of the finger F on the inner surface 31 is suppressed, and the insertion and removal of the finger F into and from the wearing space FS is guided in a smooth manner.

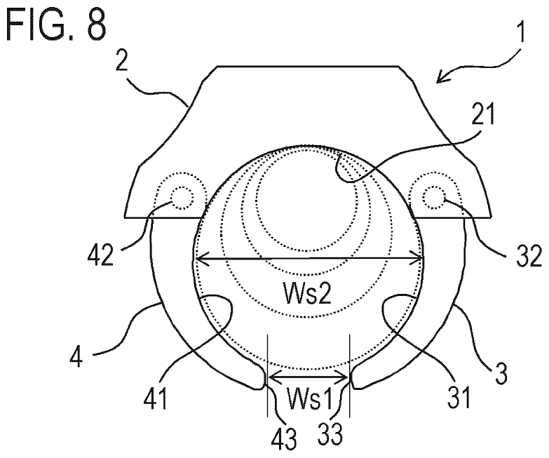

As illustrated in FIG. 8, the lengths of the first arm portion 3 and second arm portion 4 from the main body 2 are preferably set such that the ring-shaped device 1 does not slip off the thickest finger F4 that can be worn when that finger F4 is inserted. For example, it is preferable to set a gap Ws1 from the tip surface 33 and the tip surface 44, when the first arm portion 3 and second arm portion 4 open to accommodate the thickest finger F4, to not more than half a distance Ws2 corresponding to the maximum diameter of the thickest finger F4. This suppresses situations where the ring-shaped device 1 slips off the finger F when used by users having thicker fingers.

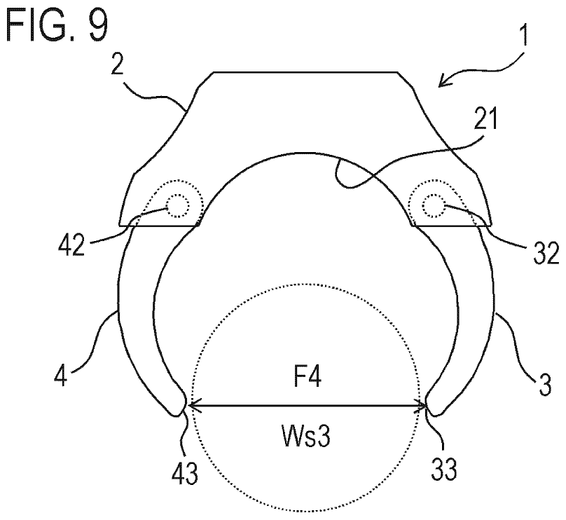

As illustrated in FIG. 9, it is preferable to set a gap Ws3 from the tip surface 33 and the tip surface 44, when the first arm portion 3 and second arm portion 4 are opened to their maximum movement limits, to be slightly larger than the maximum diameter of the thickest finger F4 that can be handled. According to this configuration, when removing the ring-shaped device 1 from the thickest finger F4, the ring-shaped device 1 can be removed in a direction perpendicular to the insertion direction ID.

Furthermore, although the lengths of the first arm portion 3 and the second arm portion 4 from the main body 2 are approximately equal in the present embodiment, the lengths may be different.

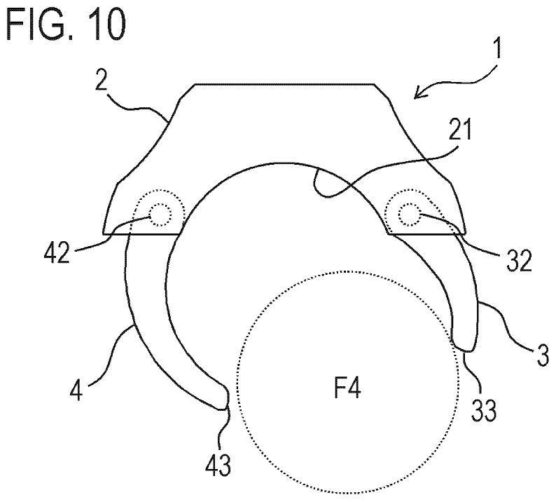

As illustrated in FIG. 10, for example, the length of the first arm portion 3 is made shorter than that of the second arm portion 4, and the rotatable range (maximum opening angle) of the first arm portion 3 relative to the main body 2 is made larger than that of the second arm portion 4. This enables control that guides the direction of movement of the finger F toward the side having the weaker biasing force when removing the finger F from the wearing space FS, such that the second arm portion 4 closes before the first arm portion 3. At this time, it is preferable to provide a tapered surface on the outer surface side of the tip of the second arm portion 4, which is closed first and is therefore located inward relative to the wearing space FS. The action of this tapered surface enables the tip of the second arm portion 4 to easily move inward when the tip of the second arm portion 4 collides with the tip of the first arm portion 3.

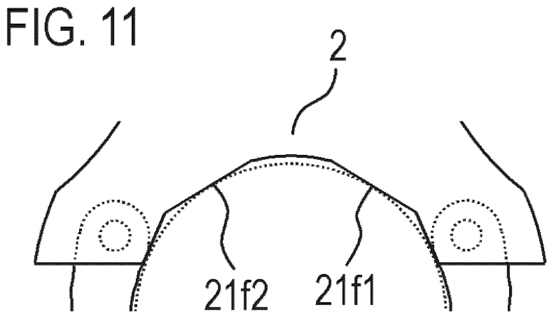

As illustrated in FIG. 11, the inner surface 21 of the main body 2 may be a concave surface in which a plurality of planes 21f1 and 21f2 that gradually vary in angle are connected to each other. In the embodiment described above, each of the inner surface 21 of the main body 2, the inner surface 31 of the first arm portion 3, and the inner surface 41 of the second arm portion 4 is configured as a concave curved surface having a curvature corresponding to the maximum diameter of the thickest finger F4, but the configuration is not limited thereto. As illustrated in FIG. 11, the concave surface may be formed by planes 21f1 and 21f2 including tangent lines to the imaginary circle (an imaginary cylindrical surface) corresponding to the maximum diameter of the thickest finger F4.

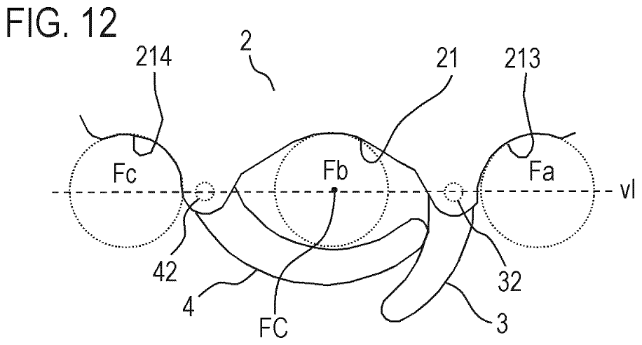

As illustrated in FIG. 12, a configuration is preferable in which a center FC of the imaginary circle corresponding to a thinnest finger Fb that can be accommodated in the wearing space FS is located on an imaginary line vl passing through the rotational center of the first arm portion 3 and the rotational center of the second arm portion 4, or closer to the main body 2 than the imaginary line vl. Furthermore, it is preferable to provide a third finger placement portion 213 and a fourth finger placement portion 214 enabling fingers Fa and Fc, which are adjacent to the finger Fb, to be placed on the outside of the first arm portion 3 and the second arm portion 4, respectively. According to this configuration, in the third wearing state illustrated in FIG. 4C, situations where the grip of the finger is inhibited by the first arm portion 3 and the second arm portion 4 are suppressed.

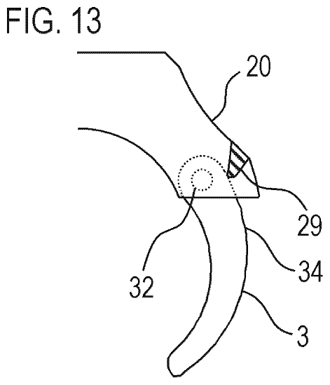

As illustrated in FIG. 13, a regulating portion 29 is provided on the inner side of the outer casing 20 of the main body 2. The regulating portion 29 is provided to be capable of contacting the outer surface 34 around the rotation shaft 32 of the first arm portion 3 in order to regulate the maximum rotation angle (the range of rotation) of the first arm portion 3. The outer casing 20 is a member requiring strength in terms of the device configuration, and the regulating portion 29 that regulates the rotation of the first arm portion 3 is provided as a part thereof. This makes it possible to increase the lifespan by improving the strength of the device and suppressing the occurrence of damage during long-term use. Such a rotation regulation configuration is similarly provided for the second arm portion 4. The regulation range for the rotation may be the same for both the first arm portion 3 and the second arm portion 4, or may be different.

### Details of Ring-Shaped Device (Arrangement of Vibrating Element)

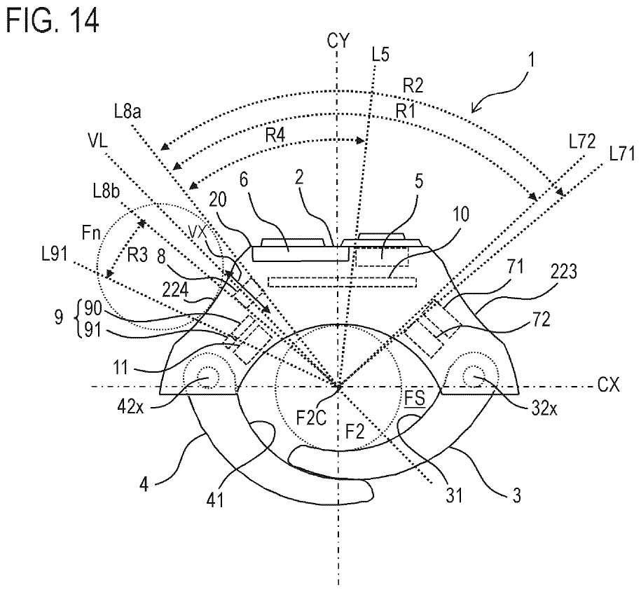

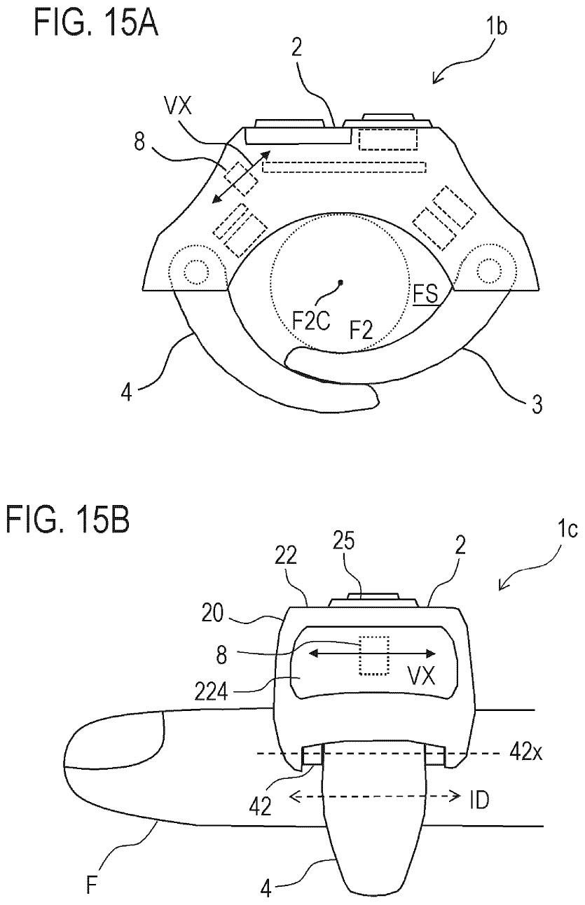

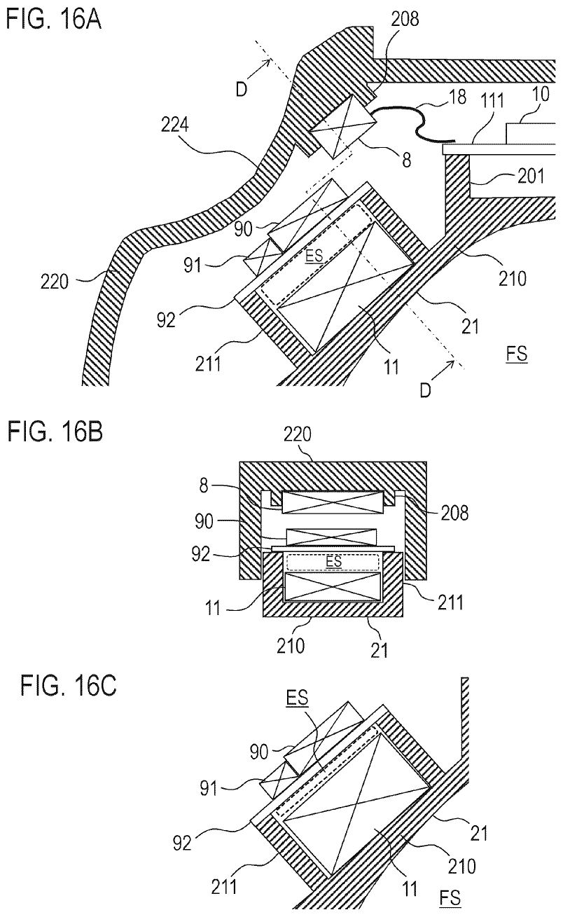

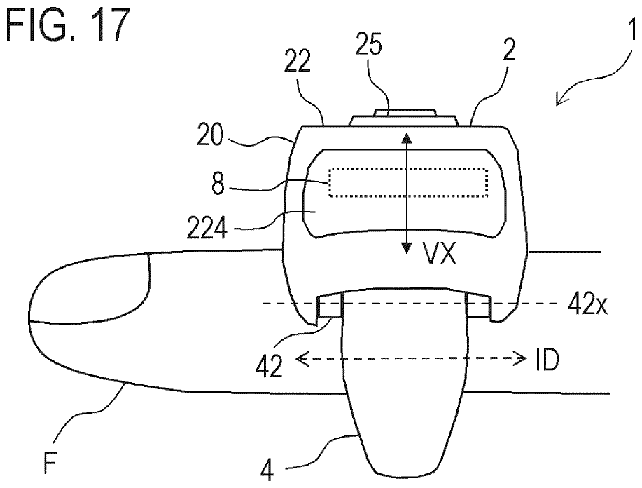

The arrangement of the vibrating element 8 in the ring-shaped device 1 according to the present embodiment will be described in detail with reference to FIGS. 14 to 17. FIG. 14 is a schematic front view of the ring-shaped device 1 according to the present embodiment, illustrating the arrangement of the vibrating element 8. FIG. 15A is a schematic front view of a ring-shaped device 1b according to Comparative Example 1. FIG. 15B is a schematic side view of a ring-shaped device 1c according to Comparative Example 2. FIG. 16A is a schematic cross-sectional view (a cross-section perpendicular to the insertion direction ID) of the area around the vibrating element 8 in the ring-shaped device 1 according to the present embodiment. FIG. 16B is a schematic cross-sectional view seen from arrow D in FIG. 16A. FIG. 16C is a schematic partial cross-sectional view of the ring-shaped device 1 according to the present embodiment, illustrating a state where the power source 11 has expanded. FIG. 17 is a side view of the ring-shaped device 1 according to the present embodiment, illustrating the arrangement of the vibrating element 8.

The manner in which vibrations generated by the vibrating element 8 are transmitted to the user can differ depending on the arrangement of the vibrating element 8 in the ring-shaped device 1. In other words, depending on the position, orientation, and the like of the vibrating element 8 in the ring-shaped device 1, the vibrations of the vibrating element 8 may not be transmitted well to the finger on which the ring-shaped device 1 is worn, making it impossible to provide the desired sensory experience to the user. In addition, it is conceivable that if a ring-shaped device is configured such that various wearing states can be used when wearing the device on a finger, the way in which the user senses the vibrations will vary if the ring-shaped device is worn in a different way (e.g., when the device is worn on a different finger).

Of the components incorporated into the ring-shaped device 1, the vibrating element 8 consumes a large amount of power, and it is therefore desirable for the vibrating element 8 to vibrate efficiently while using as little power as possible. Installing a high-capacity battery is difficult in the ring-shaped device 1, and it is therefore necessary to efficiently transmit vibrations using a small amount of power. However, the user may have difficulty feeling the vibrations if the vibrations are not strong enough.

Furthermore, it is necessary for the arrangement of the vibrating element 8 to take into account the effect of the vibrations on the operations of the other built-in devices. For example, the ring-shaped device 1 according to the present embodiment includes the inertial sensor 71, and depending on the arrangement of the vibrating element 8, there is a risk that the vibrations will be transmitted to the inertial sensor 71 and cause erroneous detections.

### Vibration Direction of Vibrating Element 8

In the ring-shaped device 1 according to the present embodiment, the vibrating element 8 is provided in a predetermined arrangement such that the user wearing the ring-shaped device 1 can more reliably sense the vibrations from the vibrating element 8. Specifically, the vibrating element 8 is disposed such that the vibration direction thereof is a direction toward the finger inserted into the wearing space FS.

As illustrated FIG. 14, an arrangement in which the imaginary line VL passing through the vibrating element 8 along a vibration axis line VX of the vibrating element 8 passes through the wearing space FS can be used as an arrangement in which the vibration direction of the vibrating element 8 is a direction toward the finger inserted into the wearing space FS. In other words, the imaginary line VL passes through an inner surface of the annular body surrounding the wearing space FS, and an outer surface opposite from the inner surface, respectively, and the annular body is constituted by the main body 2, the first arm portion 3 connected to one end side of the main body 2, and the second arm portion 4 connected to the other end side of the main body 2. In the present embodiment, the imaginary line VL passes through the inner surface 21 of the outer casing 20 of the main body 2 and the inner surface 31 of the first arm portion 3 as the inner surface of the annular body, and passes through the outer surface 22 of the outer casing 20 of the main body 2 and the outer surface opposite from the inner surface 31 of the first arm portion 3 as the outer surface of the annular body. One end of the vibrating element 8 in the direction in which the vibration axis line VX extends is located on the side close to the inner surface 21 of the outer casing 20 of the main body 2 as the inner surface of the annular body, and the other end is located on the side close to the outer surface 22 of the outer casing 20 of the main body 2 as the outer surface of the annular body.

Although fingers of various sizes can be fitted into the wearing space FS, it is preferable that the vibrating element 8 be arranged such that the vibrations of the vibrating element 8 can be sensed by the user reliably, regardless of the size of the finger on which the device is worn. Accordingly, in the present embodiment, the imaginary line VL is arranged so as to pass through a center F2C of the imaginary circular cross-section corresponding to the finger F2 as a reference center position of the finger inserted into the wearing space FS. Even when worn on a finger F1 smaller than the finger F2, or on fingers F3 and F4 larger than the finger F2, the center F2C is, in the present embodiment, used as a center position at which the user can sense the vibrations of the vibrating element 8.

The reference center position of the wearing space FS for determining the vibration direction of the vibrating element 8 is not limited to the center F2C described above, and may be determined as appropriate according to the configuration of the device. For example, the center position of the imaginary circular cross-section corresponding to a finger having an average size in the range of finger sizes that can be inserted into the wearing space FS may be the reference center position for determining the vibration direction of the vibrating element 8. Alternatively, the center of the curvature of the concave arc surface constituting the inner surface 21 may be used as the reference center position, for example.

In addition, it is preferable that the vibrating element 8 be arranged such that the stated imaginary line VL passes near the deepest part of the concave inner surface 21. As illustrated in FIG. 1A, the deepest part of the inner surface 21 may be the part where the fingers F1 to F4 of any size contact the outer casing 20. Using a configuration in which the vibrations of the vibrating element 8 are transmitted directly to such a part, the vibrations from the vibrating element 8 can be easily sensed by the user regardless of the size of the finger inserted into the wearing space FS.

Here, in the present embodiment, the vibrating element 8 is what is known as a linear vibrating actuator. In other words, the vibrating element 8 includes a moving element having a magnet and being supported by a shaft and a spring to be capable of moving back and forth in a predetermined axial direction, and a coil capable of applying current from the outside. The moving element is provided with a spindle, and excitation of the coil produced by the current being applied and the magnetic force of the magnet provided in the moving element produce reciprocal movement against the biasing force of the spring in a predetermined axial direction (a vibration axis line direction) along the shaft. Vibrations in a predetermined vibration direction are produced in the vibrating element 8 by the reciprocating movement of the moving element. In the vibrating element 8 of the present embodiment, for example, an axis passing through the center of the moving element, parallel to the axial direction of the shaft, may be the vibration axis line VX, and the direction along the vibration axis line VX may be the vibration direction of the vibrating element 8.

In addition, as illustrated in FIGS. 4A to 4C, the ring-shaped device 1 of the present embodiment can be used in a wearing state in which the device is held between a finger inserted into the wearing space FS and a finger different from the stated finger. Accordingly, causing the vibrating element 8 to produce vibrations across the fingers touching the ring-shaped device 1 (and the outer casing 20 in particular) enables the vibrations to be easily sensed by the user. It is therefore preferable that the vibrating element 8 be arranged such that, for example, the stated imaginary line VL passes through at least one of the first finger placement portion 223 and the second finger placement portion 224 of the outer casing 20.

In the present embodiment, the vibrating element 8 (or the second finger placement portion 224) is disposed such that the imaginary line VL passes through the second finger placement portion 224, as illustrated in FIG. 14. As a result, the vibrating element 8 is located between the finger F2 inserted into the wearing space FS and a finger Fn placed on the second finger placement portion 224, and the vibrations can be efficiently and effectively transmitted to each of the finger F2 and the finger Fn.

More preferably, the vibrating element 8 may be arranged such that the imaginary line VL passes through both a region of the inner surface 21 where the finger inserted into the wearing space FS particularly comes into contact, and a region of the second finger placement portion 224 where the finger placed on the second finger placement portion 224 particularly comes into contact. The concave shape of the inner surface 21 and the outer circumferential shape of the finger inserted into the wearing space FS are normally not an exact match, and the outer circumference of the finger does not necessarily contact all regions of the inner surface 21. Similarly, the concave shape of the second finger placement portion 224 and the outer circumferential shape of the finger placed on the second finger placement portion 224 are normally not an exact match, and the outer circumference of the finger does not necessarily contact all regions of the second finger placement portion 224. Therefore, for example, arranging the vibrating element 8 such that the imaginary line VL passes through the stated region of the inner surface 21 and passes through the center of the finger inserted into the wearing space FS makes it possible to efficiently and effectively transmit vibrations to the finger inserted into the wearing space FS. Similarly, arranging the vibrating element 8 such that the imaginary line VL passes through the stated region of the second finger placement portion 224 and passes through the center of the finger placed on the second finger placement portion 224 makes it possible to efficiently and effectively transmit vibrations to the finger placed on the second finger placement portion 224.

In addition to the first and second finger placement portions 223 and 224, the button switch 6 and the touch sensor 5 serving as operation members are provided on the outer surface 22 of the outer casing 20, which serves as a contacted portion with which fingers different from the finger inserted into the wearing space FS come into contact. Accordingly, for example, in a ring-shaped device as a variant of the present embodiment, the vibrating element 8 may be arranged such that the stated imaginary line VL passes through the button switch 6 and the touch sensor 5. Note that if erroneous operations caused by vibrations of the vibrating element 8 are a concern, the touch sensor 5 may be disposed at a position distanced from the stated imaginary line VL passing through the vibrating element 8. As will be described later, in the present embodiment, the touch sensor 5 is disposed at a predetermined distance from the vibrating element 8 in a circumferential direction around the center F2C of the imaginary circle corresponding to the finger F2, which serves as the center of the wearing space FS.

The arrangement of the vibrating element 8 in the ring-shaped device 1b according to Comparative Example 1, illustrated in FIG. 15A, is different from that in the ring-shaped device 1 according to the present embodiment. Specifically, in the ring-shaped device 1b, the vibration axis line VX of the vibrating element 8 is in a direction orthogonal to the vibration axis line VX of the vibrating element 8 in the ring-shaped device 1, and is in a direction orthogonal to the insertion direction ID in which the finger is inserted into the wearing space FS. Accordingly, in Comparative Example 1, there is a concern that the imaginary line VL passing through the vibrating element 8 along the vibration axis line VX will not pass through the wearing space FS, and the vibrations of the vibrating element 8 will not be sufficiently transmitted to the finger wearing the ring-shaped device 1b.

In Comparative Example 1, the vibration direction of the vibrating element 8 is a direction following the circumferential direction around the finger, and there is therefore a concern that the vibration of the vibrating element 8 will cause the ring-shaped device 1b and the finger inserted into the wearing space FS to move relative to each other in the circumferential direction. In other words, there is a concern that the vibration of the vibrating element 8 will cause the ring-shaped device 1b to rotate relative to the finger (the wearing position of the ring-shaped device 1b will shift in a direction around the outer circumference of the finger).

Like the ring-shaped device 1b according to Comparative Example 1, the arrangement of the vibrating element 8 in the ring-shaped device 1c according to Comparative Example 2, illustrated in FIG. 15B, is different from that in the ring-shaped device 1 according to the present embodiment. Specifically, in the ring-shaped device 1c, the vibration axis line VX of the vibrating element 8 is in a direction orthogonal to the vibration axis line VX of the vibrating element 8 in the ring-shaped device 1 according to the present embodiment, and is in a direction along the insertion direction ID in which the finger is inserted into the wearing space FS. Accordingly, in Comparative Example 2, there is a concern that the imaginary line VL passing through the vibrating element 8 along the vibration axis line VX will not pass through the wearing space FS, and the vibrations of the vibrating element 8 will not be sufficiently transmitted to the finger wearing the ring-shaped device 1c.

In addition, in Comparative Example 2, the vibration direction of the vibrating element 8 is a direction along the insertion direction ID in which the finger is inserted into the wearing space FS, and there is thus a concern that the vibrations from the vibrating element 8 will cause the ring-shaped device 1b and the finger inserted into the wearing space FS to move relative to each other in the insertion direction ID. In other words, there is a concern that the vibrations from the vibrating element 8 will cause the ring-shaped device 1c to move relative to the finger in the insertion direction ID (shift the wearing position of the ring-shaped device 1b relative to the finger in the insertion direction ID).

Unlike the foregoing Comparative Examples 1 and 2, according to the ring-shaped device 1 of the present embodiment, the vibrations from the vibrating element 8 can be effectively transmitted to the finger on which the ring-shaped device 1 is worn. In addition, with the ring-shaped device 1 according to the present embodiment, there is no concern that the vibrations from the vibrating element 8 will affect the wearing state of the ring-shaped device 1 on the finger as in Comparative Examples 1 and 2, which makes it possible to achieve a stable wearing state.

### Arrangement of Vibrating Element 8 in Outer Casing 20

It is preferable that the vibrating element 8 be disposed near the part of the outer casing 20 that forms the outer surface 22 on which the first and second finger placement portions 223 and 224, the button switch 6, and the touch sensor 5 are disposed, preferably in contact with that part. Transmitting strong vibrations to the outer part of the outer casing 20 makes it easier to transmit the vibrations not only to the finger inserted into the wearing space FS, but also to fingers other than that finger, which in turn makes it easier for the user to sense the vibrations.

As illustrated in FIGS. 16A and 16B, the outer casing 20 is constituted by an inside outer casing 210 as a first housing and an outside outer casing 220 as a second housing. The inside outer casing 210 includes the inner surface 21 that forms the wearing space FS. The outside outer casing 220 includes the outer surface 22 on which the first and second finger placement portions 223 and 224, the button switch 6, the touch sensor 5, and the like are disposed. The inside outer casing 210 and the outside outer casing 220 are coupled to each other by screws or the like, and between the two, a substantially arc-shaped accommodating space (an interior space of the outer casing 20) is formed which accommodates built-in devices such as the inertial sensor 71, the geomagnetic sensor 72, the vibrating element 8, the communication portion 9, the control portion 10, the power source 11, and the like.

The vibrating element 8 is mounted on a mounting portion 208 provided on the inner surface of the outside outer casing 220 that forms the stated accommodating space of the outer casing 20. Because the vibrations from the vibrating element 8 are directly transmitted to the outside outer casing 220, the vibrations are easily transmitted to fingers touching the first and second finger placement portions 223 and 224, the button switch 6, the touch sensor 5, and the like provided in the outside outer casing 220.

On the other hand, the inner surface of the inside outer casing 210 that forms the stated accommodating space in the outer casing 20 is provided with a mounting portion 201 on which a control board 111, including a control IC serving as the control portion 10, is mounted, and a mounting portion 211 on which the communication portion 9 and the power source 11 are mounted. Although not illustrated, the stated inner surface of the inside outer casing 210 is further provided with a mounting portion or the like on which on which a board including the inertial sensor 71, the geomagnetic sensor 72, and the like are mounted.

In other words, the vibrating element 8 is disposed at a distance from the other built-in devices within the state accommodating space of the outer casing 20 (installed at a distance from the boards on which the other built-in devices are mounted). Although the operation of the vibrating element 8 (the application of current to the coil) is controlled by control signals from the control portion 10, the vibrating element 8 is provided at a distance from the board 111 on which the control portion 10 is mounted, and is connected to the board 111 by a flexible cable 18. The vibrating element 8 is also distanced from other boards mounted on the inside outer casing 210 of the outer casing 20. This provides a configuration in which the vibrations from the vibrating element 8 are not directly transmitted to the various devices provided in the inside outer casing 210.

Note that if more importance is to be placed on transmitting the vibrations from the vibrating element 8 to the finger inserted into the wearing space FS, the configuration may be such that, for example, the mounting portion 208 is extended to a position closer to the inside outer casing 210, and the vibrating element 8 is disposed closer to the inner surface 21 than the outer surface 22.

Furthermore, the mounting portion 211 on which the communication portion 9 and the power source 11 are mounted is configured to form an empty space ES as a shared space shared by the communication portion 9 and the power source 11. The communication portion 9 includes a wireless module 90, a wireless antenna 91, and a wireless board 92 on which those elements are mounted. In the present embodiment, the power source 11 is a lithium-ion battery, which has a property of expanding during abnormal conditions such as when high temperatures arise, and therefore includes, for example, a gas venting valve for venting gas when the battery expands. To ensure sensitivity, it is preferable to avoid placing obstructions which inhibit the reception of radio waves, and conductors in particular, around the wireless antenna 91 to the greatest extent possible, and thus a space for ensuring sensitivity is normally provided around the wireless antenna 91. In addition, because the power source 11 is a lithium-ion battery, it is necessary to provide space in the surroundings to allow expansion when the aforementioned abnormal conditions arise.

As illustrated in FIG. 16A, the mounting portion 211 is configured to support the wireless board 92 and the power source 11 such that the empty space ES is formed between the wireless board 92 of the communication portion 9 and the power source 11. As illustrated in FIG. 16C, this empty space ES provides space for allowing the power source 11 to expand for ensuring the sensitivity around the wireless antenna 91 as mentioned earlier. In other words, the empty space ES is a space shared by the communication portion 9 and the power source 11, and having the space required by the communication portion 9 and the power source 11 being shared makes it possible to save space in the outer casing 20, increase the freedom of the layout of the interior space within the outer casing 20, and the like.

In addition, as illustrated in FIGS. 14 and 17, the vibrating element 8 is disposed such that the longitudinal direction thereof is along the insertion direction ID of the finger F. The vibrating element 8 provided in the ring-shaped device 1 according to the present embodiment has a substantially cuboid external shape, and aligning the longitudinal direction thereof with the insertion direction ID of the finger F makes it possible to arrange the vibrating element 8 without taking up space in the circumferential direction in the substantially arc-shaped inside of the outer casing 20. The freedom with which the shape of the outer casing 20 can be designed along the outer circumference of the finger can therefore be increased.

In the present embodiment, as illustrated in FIG. 17, the vibrating element 8 is disposed such that the direction in which the vibration axis line VX of the vibrating element 8 extends is orthogonal to the insertion direction ID in which the finger is inserted into the wearing space FS, but the stated direction need not be orthogonal. In other words, the direction may be an intersecting direction having a slight angle relative to the orthogonal direction, to the extent that the vibrations from the vibrating element 8 can be transmitted to the finger inserted into the wearing space FS, the fingers placed on the first and second finger placement portions 223 and 224, and the like to a sufficient degree.

### Arrangement Relationship between Vibrating Element 8 and Other Built-In Devices

As illustrated in FIGS. 14 and 16A, in the ring-shaped device 1 of the present embodiment, built-in devices aside from the vibrating element 8, such as the communication portion 9, the control portion 10, the power source 11, the inertial sensor 71, and the geomagnetic sensor 72, are attached to the inside outer casing 210. In addition, the vibrating element 8 and the other built-in devices described above are arranged within the outer casing 20 spaced apart from each other in the circumferential direction around the center F2C of the imaginary circle corresponding to the finger F2, which is the center of the wearing space FS.

In the arrangement viewed in the insertion direction ID of the finger, as illustrated in FIG. 14, an axis parallel to an imaginary line passing through the rotational center (rotation axis line 32x) of the first arm portion 3 and the rotational center (rotation axis line 42x) of the second arm portion 4, and passing through the center F2C serving as the reference center position, is taken as an axis CX. An axis orthogonal to the axis CX and passing through the center F2C is taken as an axis CY. In a coordinate system formed by the axis CX and the axis CY, the inertial sensor 71, the geomagnetic sensor 72, and the touch sensor 5 are located in a first quadrant, the vibrating element 8, the communication portion 9, and the power source 11 are located in a second quadrant, and the control portion 10 is located straddling the first quadrant and the second quadrant. The communication portion 9, the control portion 10, and the power source 11 located in the same second quadrant as the vibrating element 8 are disposed in positions that do not overlap with the imaginary line VL passing through the vibrating element 8 (positions offset from the vibrating element 8 when viewed in the vibration direction of the vibrating element 8), in terms of the positional relationship in the circumferential direction around the center F2C.

Note that in the coordinate system formed by the axis CX and the axis CY, the region where the first arm portion 3 and the second arm portion 4 open and close corresponds to the periphery of a boundary between a third quadrant and a fourth quadrant, and the region where the various built-in devices including the vibrating element 8 are arranged is a region on the opposite side therefrom relative to the axis CX. In other words, the configuration is such that the first arm portion 3 and the second arm portion 4 hold the finger from the opposite side from the vibrating element 8 and push the finger from the third/fourth quadrant side toward the first/second quadrant side, i.e., the main body 2 side, which makes it easy to transmit the vibrations from the vibrating element 8 to the finger.

As described above, the vibrating element 8 in the present embodiment is configured to operate by applying current through the coil, and there is thus a concern that the magnetic force, magnetic fields, and the like generated by energizing the coil will affect the operations of the other built-in devices. For example, there is a concern that the magnetic force, magnetic fields, and the like generated by the vibrating element 8 may be detected as noise by the inertial sensor 71 or the geomagnetic sensor 72. In addition, although the communication portion 9 is constituted by the wireless module 90 and the wireless antenna 91, there is a concern that the magnetic force, magnetic fields, and the like generated by the vibrating element 8 will produce noise in the wireless antenna 91, and that the metal material of which the vibrating element 8 is formed will affect the sensitivity of the wireless antenna 91. Furthermore, as described above, there is a concern that the vibrations from the vibrating element 8 will cause the touch sensor 5 to operate incorrectly.

The geomagnetic sensor 72 is distanced to form an angle of at least no less than 60 degrees, and preferably no less than 90 degrees, relative to the vibrating element 8 in the circumferential direction around the center F2C. The separation distance between the geomagnetic sensor 72 and the vibrating element 8 may be defined by a minimum distance between the geomagnetic sensor 72 and the vibrating element 8 in the circumferential direction around the center F2C, for example. For example, an imaginary line passing through the center F2C and the part of the geomagnetic sensor 72 that is closest to the vibrating element 8 in the circumferential direction is taken as L72. In addition, an imaginary line passing through the center F2C and the part of the vibrating element 8 that is closest to the geomagnetic sensor 72 in the circumferential direction is taken as L8a. It is preferable to arrange the geomagnetic sensor 72 and the vibrating element 8 such that an angle R1 formed by the imaginary line L72 and the imaginary line L8a around the center F2C is within the stated angle range.

Like the geomagnetic sensor 72, the inertial sensor 71 is distanced to form an angle of at least no less than 60 degrees, and preferably no less than 90 degrees, relative to the vibrating element 8 in the circumferential direction around the center F2C. Also, like the geomagnetic sensor 72, the separation distance between the inertial sensor 71 and the vibrating element 8 also may be defined by a minimum distance between the inertial sensor 71 and the vibrating element 8 in the circumferential direction around the center F2C, for example. For example, an imaginary line passing through the center F2C and the part of the inertial sensor 71 that is closest to the vibrating element 8 in the circumferential direction is taken as L71. In addition, an imaginary line passing through the center F2C and the part of the vibrating element 8 that is closest to the inertial sensor 71 in the circumferential direction is taken as L8a. It is preferable to arrange the inertial sensor 71 and the vibrating element 8 such that an angle R2 formed by the imaginary line L71 and the imaginary line L8a around the center F2C is within the stated angle range.

The communication portion 9 is distanced such that the wireless antenna 91 forms an angle of at least no more than 30 degrees, and preferably no more than 90 degrees, relative to the vibrating element 8 in the circumferential direction around the center F2C. The separation distance between the wireless antenna 91 and the vibrating element 8 may also be defined by a minimum distance between the wireless antenna 91 and the vibrating element 8 in the circumferential direction around the center F2C, for example. For example, an imaginary line passing through the center F2C and the part of the wireless antenna 91 that is closest to the vibrating element 8 in the circumferential direction is taken as L91. In addition, an imaginary line passing through the center F2C and the part of the vibrating element 8 that is closest to the wireless antenna 91 in the circumferential direction is taken as L8b. It is preferable to arrange the wireless antenna 91 (the communication portion 9) and the vibrating element 8 such that an angle R3 formed by the imaginary line L91 and the imaginary line L8b around the center F2C is within the stated angle range.

The touch sensor 5 is distanced to form an angle of at least no more than 30 degrees, and preferably no more than 90 degrees, relative to the vibrating element 8 in the circumferential direction around the center F2C. The separation distance between the touch sensor 5 and the vibrating element 8 also may be defined by a minimum distance between the touch sensor 5 and the vibrating element 8 in the circumferential direction around the center F2C, for example. For example, an imaginary line passing through the center F2C and the part of the touch sensor 5 that is closest to the vibrating element 8 in the circumferential direction is taken as L5. In addition, an imaginary line passing through the center F2C and the part of the vibrating element 8 that is closest to the touch sensor 5 in the circumferential direction is taken as L8a. It is preferable to arrange the touch sensor 5 and the vibrating element 8 such that an angle R4 formed by the imaginary line L5 and the imaginary line L8a around the center F2C is within the stated angle range.

Here, the center position of the wearing space FS for determining the separation distance between the vibrating element 8 and the other built-in devices, the touch sensor 5, and the like in the circumferential direction is not limited to the center F2C described above, and may be determined as appropriate in accordance with the configuration of the device. For example, the center position of the imaginary circular cross-section corresponding to a finger having an average size in the size range of fingers that can be inserted into the wearing space FS may be used as a reference. Alternatively, the center of the curvature of the concave arc surface constituting the inner surface 21 may be used as the reference, for example.

In addition, although the present embodiment describes an example in which what is known as a linear vibrating actuator is used as the vibrating element 8, a different vibrating actuator may be used as the vibrating element 8. For example, a vibrating actuator using a piezoelectric element may be used, or a vibrating actuator using an eccentric motor may be used.

### Details of Ring-Shaped Device (Configuration around Operated Portion)

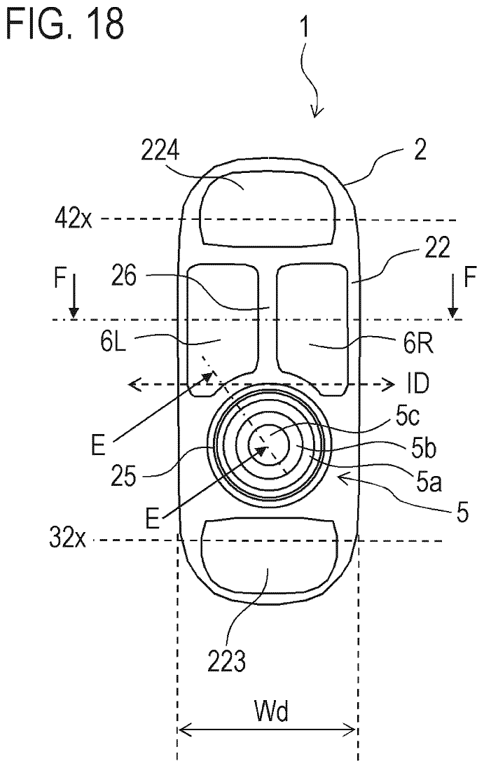

A configuration for improving usability in the ring-shaped device 1 according to the present embodiment will be described with reference to FIGS. 18 to 25B.

FIG. 18 is a top view illustrating the configuration of an operated surface of the ring-shaped device 1. As illustrated in FIG. 18, the ring-shaped device 1 according to the present embodiment has an operated surface, provided with the touch sensor 5 and the button switches 6R and 6L as operated portions, on the outer surface 22 of the outer casing 20 of the main body 2. As the usage mode of the ring-shaped device 1, it is assumed that the user will perform various input operations without looking at the hand on which the ring-shaped device 1 is worn. In other words, the user identifies and distinguishes the touch sensor 5 and the button switches 6R and 6L by relying on the tactile sensation of their finger touching the operated surface, and then performs the desired input operations. It is therefore necessary for the user of the ring-shaped device 1 to be capable of both reliably identifying the positions of the touch sensor 5 and the button switches 6R and 6L without looking at the operated surface, and smoothly operating the touch sensor 5 and the button switches 6R and 6L without erroneous operations.

Here, as illustrated in FIGS. 4A to 4C, the touch sensor 5 and the button switches 6R and 6L are arranged on the operated surface such that the touch sensor 5 is on the wrist side of the hand on which the ring-shaped device 1 is worn, and the button switches 6R and 6L are arranged on the fingertip side. In other words, the positional relationship is such that, relative to the finger inserted into the wearing space FS, the touch sensor 5 is arranged on the front side in the circumferential direction around the insertion direction in which the finger is inserted, and the button switches 6R and 6L are arranged on the back side. An operating mode normally assumed involves inserting a finger other than the thumb (typically the index finger or middle finger) into the wearing space FS, with the thumb extending toward the back side from in front of the touch sensor 5 then operating the touch sensor 5 and the button switches 6R and 6L. Although FIGS. 4A to 4C illustrate a case where the ring-shaped device 1 is worn on the right hand, the ring-shaped device 1 may be worn on the left hand.

The first finger placement portion 223 is a finger placement portion (a first recessed portion) arranged on the stated front side of the outer casing 20 of the main body 2. The thumb may be placed on the first finger placement portion 223 when the touch sensor 5 and the button switches 6R and 6L are not to be operated, for example. The second finger placement portion 224 is a finger placement portion (a second recessed portion) arranged on the stated back side of the outer casing 20 of the main body 2. For example, as illustrated in FIG. 4B, in a wearing state in which the middle finger is inserted into the wearing space FS, the index finger can be placed on the second finger placement portion 224. Through this, the ring-shaped device 1 is held in a holding state such that a part thereof is cradled in the palm of the hand and the main body 2 is held down with the index finger, which makes it possible to stabilize the fit of the ring-shaped device 1. The first finger placement portion 223 and the second finger placement portion 224 also provide a place where the fingers can be pulled back when not operating the device, which suppresses situations where the operated portion is unintentionally touched by a finger and helps prevent erroneous operations.

In addition, in the ring-shaped device 1 according to the present embodiment, a width Wd of the main body 2 indicated in FIG. 18 (the width of the main body 2 in the insertion direction ID in which the finger is inserted into the wearing space FS) is approximately 25.0 mm. This is a setting corresponding to the spacing of the joints of the finger inserted into the wearing space FS, or the width of the thumb used to operate the touch sensor 5 and button switches 6R and 6L.

Assuming operation by the thumb, in the ring-shaped device 1 according to the present embodiment, the touch sensor 5 and the button switches 6R and 6L are configured in a predetermined dimensional shape and arrangement, and a first boundary identification rib 25 and a second boundary identification rib 26 (described later) are also provided. Because the thumb is the widest finger on the human hand, a configuration is necessary in which the touch sensor 5 and the button switches 6R and 6L as the operated portion can, despite their small size, be distinguished between when pressing.

### Boundary Identification Ribs

As illustrated in FIG. 18 and the like, the ring-shaped device 1 of the present embodiment includes the first boundary identification rib 25 and the second boundary identification rib 26 as configurations enabling the user to distinguish between the touch sensor 5 and the button switches 6R and 6L, and recognize the arrangements thereof, solely by the tactile sensation of the finger touching the operated surface. The first boundary identification rib 25 serving as a first rib and the second boundary identification rib 26 serving as a second rib are configured as part of the outer casing 20. Furthermore, the shapes and arrangement of the touch sensor 5 and the button switches 6R and 6L as the operated portion are configured to be suitable for operation solely by the tactile sensation of the finger.

The first boundary identification rib 25 is an annular rib disposed around the outer circumference of the touch sensor 5. By feeling the annular convex shape of the first boundary identification rib 25 with their finger, the user can recognize that the touch sensor 5 is present on the inner side thereof. In the present embodiment, the touch sensor 5 is shaped so as to project higher than the first boundary identification rib 25. Therefore, by feeling that a convex portion projecting further than the annular convex shape is present on the inner side thereof with their finger, the user can recognize that that part is the touch sensor 5.

In addition, a part of the annular first boundary identification rib 25 is a part located between the touch sensor 5 and the button switches 6R and 6L. Accordingly, the boundary between the touch sensor 5 serving as a first operated portion and the button switches 6R and 6L serving as a second operated portion can be recognized by the user on the basis of the positional relationship between the first boundary identification rib 25 and the second boundary identification rib 26 (described later).

The second boundary identification rib 26 is provided extending in the circumferential direction, on the outer surface 22 of the outer casing 20 of the main body 2, between the button switch 6R and the button switch 6L arranged in the insertion direction ID in which the finger is inserted into the wearing space FS of the ring-shaped device 1. The second boundary identification rib 26 projects higher than the top surface of the button switches 6R and 6L. Accordingly, by feeling the convex shape extending in the circumferential direction of the finger inserted into the wearing space FS (around the insertion direction of the finger) with their finger, the user can recognize that the button switches 6R and 6L are the low parts adjacent on both sides of that convex shape in the insertion direction ID of the finger. In other words, the second boundary identification rib 26 can enable the user to recognize the boundary between the button switch 6R serving as the first operated portion and the button switch 6L serving as the second operated portion.

In the present embodiment, the first boundary identification rib 25 is arranged on the front side in the circumferential direction of the finger relative to the second boundary identification rib 26, and the pair of button switches 6R and 6L are arranged symmetrically in the insertion direction ID of the finger, relative to the second boundary identification rib 26. These configurations disposed around the second boundary identification rib 26 can be said to have a function of providing the user with the certainty that the convex shape extending in the circumferential direction felt by the finger is the second boundary identification rib 26.

In other words, the annular convex shape of the first boundary identification rib 25 is a characteristic shape that can be recognized solely by feeling the shape with a finger, and is a shape that can be easily recognized by the user. By feeling, with their finger, that there is a convex shape extending in the circumferential direction on the back side of the annular convex shape in the circumferential direction of the finger, the user can confidently recognize that the convex shape in the circumferential direction is the second boundary identification rib 26.

Furthermore, by enabling the user to feel that the shapes on both sides of the convex shape extending in the circumferential direction of the finger are symmetrical in the finger insertion direction ID, the user can confidently recognize that that convex shape in the circumferential direction is the second boundary identification rib 26. Furthermore, the user can confidently recognize that the right side of the symmetrical shape on both sides of the circumferential convex shape in the finger insertion direction ID is the button switch 6R, and the left side is the button switch 6L.

### Dimensional Relationship, etc. of First Boundary Identification Rib 25

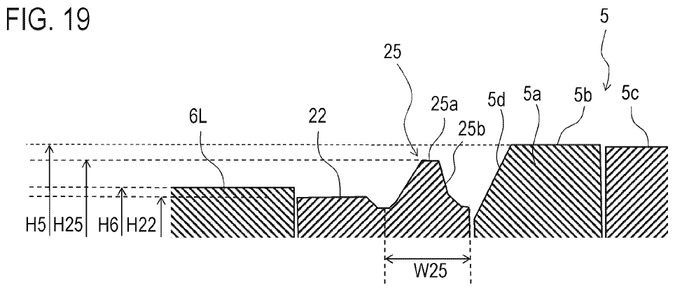

FIG. 19 is a schematic cross-sectional view seen from arrow E in FIG. 18, and illustrates the height relationships among the touch sensor 5, the button switches 6R and 6L, the first boundary identification rib 25, and the like. As illustrated in FIG. 19, a height H5 of the touch sensor 5 is higher than a height H25 of the first boundary identification rib 25. In addition, a height H6 of the button switches 6L and 6R is the same as or higher than a height H22 of the outer surface 22 of the outer casing 20 of the main body 2. In addition, the height H25 of the first boundary identification rib 25 is the same as or higher than the height H6 of the button switches 6L and 6R. In other words, the configuration is such that the heights of the outer surface 22 of the outer casing 20 of the main body 2, the touch sensor 5, the button switches 6R and 6L, and the first boundary identification rib 25 satisfy the relationship H22≤H6≤H25<H5.

Here, in the present embodiment, the configuration is such that a difference in the heights of the first boundary identification rib 25 and the button switches 6L and 6R (H25-H6) is at least 0.3 mm. In addition, in the present embodiment, a width W25 of the first boundary identification rib 25 (the difference between the inner diameter and the outer diameter of the first boundary identification rib 25) is configured to be at least 1.5 mm.

The height H25 and the width W25 of the first boundary identification rib 25 are set from the perspective of preventing erroneous operations when operating the device without looking. If the height H25 is too low or the width W25 is too narrow, it may be difficult to identify the first boundary identification rib 25. Conversely, if the height H25 is too high or the width W25 is too wide, the operation of the touch sensor 5 may be hindered. The above-described numerical ranges of the dimensions are merely examples, and may be set to a suitable numerical values as appropriate from the perspective of usability, in accordance with the configuration of the device.

Arranging the first boundary identification rib 25 between the button switches 6R and 6L and the touch sensor 5 suppresses situations where the touch sensor 5 is operated unintentionally when the button switches 6R and 6L, which are pushbuttons, are pressed.

Here, the touch sensor 5 is what is known as an optical pointing device, and includes a photosensor portion 5c provided with a detection window in the center of a circular upper surface 5b of a button portion 5a. A pointing operation, a flicking operation, and the like can be performed by moving a finger on the photosensor portion 5c (moving the finger along a plane). Note that the touch sensor 5 is not limited to an optical pointing device, and may be a capacitive pointing device, for example.

Furthermore, the touch sensor 5 is configured such that the button portion 5a can move up and down, and such that an input operation of pressing the circular upper surface 5b of the button portion 5a can be made. In other words, the button portion 5a is provided so as to be capable of movement in which a depression amount changes with respect to the first boundary identification rib 25 surrounding the outer circumference thereof, and an input state can be formed by depressing the circular upper surface 5b and to sink on the inner side of the annular first boundary identification rib 25. The button portion 5a is biased by a biasing member such as a spring (not shown) so as to be positioned at a height (a home position) projecting higher than the first boundary identification rib 25 unless a particular external force is applied thereto. The user can perform an input operation by pressing the circular upper surface 5b of the button portion 5a against the biasing force of the biasing member. When the finger is removed and the pressed state of the button portion 5a (the input state) is released, the button portion 5a returns to the height (the home position) projecting higher than the first boundary identification rib 25 due to the biasing force of the biasing member.

Here, it is preferable that the height of the circular upper surface 5b of the button portion 5a for creating the input state through a pressing operation be a height lower than the height of the first boundary identification rib 25. This makes it possible to configure the device such that the button portion 5a does not easily enter the input state even if the user accidentally touches the button portion 5a with their finger when checking the first boundary identification rib 25 with their finger, for example. In other words, erroneous operations causing the button portion 5a to enter the input state by mistake can be suppressed.

In addition, an annular surface region surrounding the outer circumference of the photosensor portion 5c on the circular upper surface 5b, and an inclined region 25b extending from the base of the first boundary identification rib 25 to an apex part 25a of the first boundary identification rib 25, are interposed between the apex part 25a and the photosensor portion 5c. This secures a predetermined distance between the apex part 25a of the first boundary identification rib 25 and the photosensor portion 5c. This also makes it possible to suppress the occurrence of erroneous operations detected as inputs to the photosensor portion 5c caused by the user moving their finger to confirm the first boundary identification rib 25 by feel as described above.

In addition, the configuration includes an inclined surface 5d in which the outer circumference of the circular upper surface 5b of the button portion 5a tapers out, and a distance is also secured between the apex part 25a of the first boundary identification rib 25 and the circular upper surface 5b. This makes it possible to suppress situations where movement of the finger for confirming the first boundary identification rib 25 by feel as described above results in a pressing operation of the button portion 5a of the touch sensor 5. In other words, the occurrence of erroneous operations can be suppressed.

### Dimensional Relationship, etc. of Second Boundary Identification Rib 26

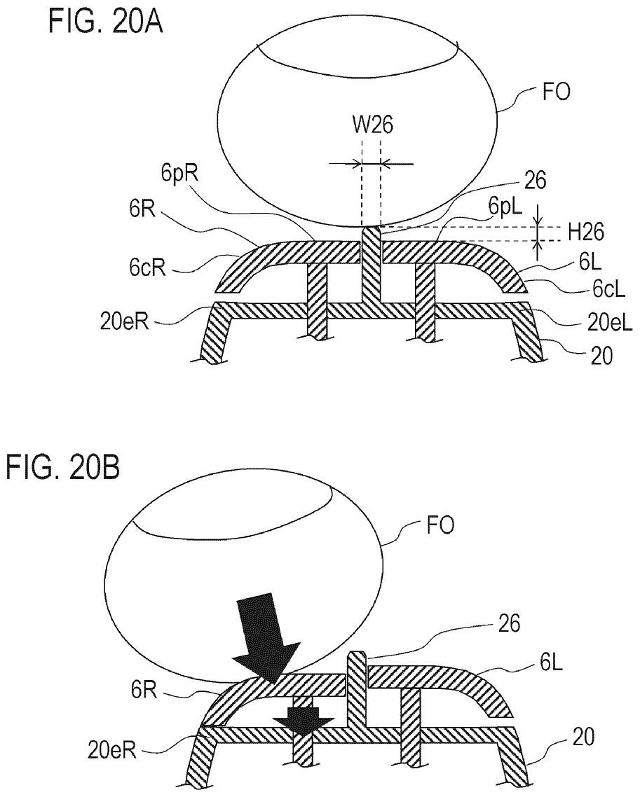

FIGS. 20A and 20B are schematic cross-sectional views seen along arrow F in FIG. 18. As illustrated in FIGS. 20A and 20B, the second boundary identification rib 26 projects outward (upward) from the upper surface of each of the button switches 6R and 6L, and in the present embodiment, a projection height H26 thereof is configured to be within the range of at least 0.3 mm and not more than 1.0 mm. In addition, in the present embodiment, a width of the second boundary identification rib 26 between the button switches 6R and 6L (the width in the insertion direction ID of the finger) W26 is configured to be within the range of at least 1.0 mm and not more than 2.5 mm.

The projection height H26 and the width W26 of the second boundary identification rib 26 are set from the perspective of preventing erroneous operations when operating the device without looking. If the projection height H26 is too low or the width W26 is too narrow, it may be difficult to identify the second boundary identification rib 26. Conversely, if the projection height H26 is too high or the width W26 is too wide, operations for pressing the button switches 6R and 6L may be hindered. The above-described numerical ranges of the dimensions are merely examples, and may be set to a suitable numerical values as appropriate from the perspective of usability, in accordance with the configuration of the device.

Here, the button switches 6R and 6L have curved (convex arc-shaped surface) end portions 6cR and 6cL on the outer sides, in the insertion direction ID of the finger, of planar portions 6pR and 6pL, respectively. The end portions 6cR and 6cL are located upstream from corner portions 20eR and 20eL, located between the outer circumferential surface and a side surface of the outer casing 20 of the main body 2, in the direction in which the button switches 6R and 6L are pressed (radially outward with respect to the reference center of the wearing space FS).

In other words, the end portions 6cR and 6cL of the button switches 6R and 6L are configured to form part of corresponding corner portions between the outer circumferential surface and the side surface of the main body 2. According to this configuration, the operations for pressing the button switches 6R and 6L can be performed as if by pressing the corner portions of the substantially arc-shaped structure including the outer casing 20 of the main body 2 and the button switches 6R and 6L. According to this configuration, the button switches 6R and 6L can be pressed despite the small size of the main body 2. In particular, the corner portions of the structure have shapes easy to feel with a finger when operating the device without looking, and the usability can therefore be improved by configuring the corner portions such that the user can perform pressing operations by relying on the feel of the corner portions.

Although the present embodiment describes the end portions 6cR and 6cL as end portions having curved surfaces with respect to the planar portions 6pR and 6pL, the end portions may be corner portions constituted by linear surfaces.

### Dimensional Relationship, etc. between Touch Sensor 5 and Button Switches 6R and 6L

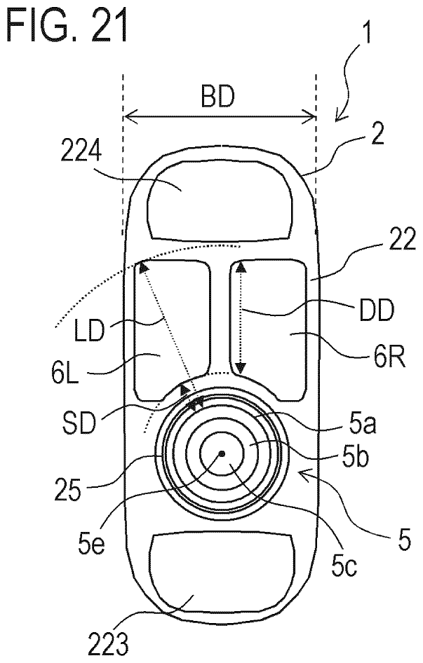

FIG. 21 is a top view illustrating the configuration of the operated surface of the ring-shaped device 1, and is a diagram illustrating the shape and arrangement relationship of the touch sensor 5 and the button switches 6R and 6L. The sizes and arrangement of the button switches 6R and 6L are defined as various dimensions based on a center 5e of the touch sensor 5 (the photosensor portion 5c) (the center of the annular shape of the first boundary identification rib 25) when the operating surface of the main body 2 is seen in plan view.

For example, a combined width BD of the button switch 6R and the button switch 6L in the insertion direction ID of the finger is configured to be not more than 25.0 mm, and preferably not more than 10.0 mm. In addition, a minimum distance SD between the touch sensor 5 and the button switches 6R and 6L is configured to be at least 1.5 mm, and a maximum distance LD is configured to be not more than 20.0 mm. Note that these numerical ranges are suitable for the ring-shaped device 1 according to the present embodiment. In other words, the ranges are merely examples, and may be set as appropriate such that the amount of movement of the finger between the touch sensor 5 and the button switches 6R and 6L is reduced to the greatest extent possible but within a range that is reasonable with respect to the amount of movement of the finger required for operations.

In addition, a width DD of the button switches 6R and 6L in the circumferential direction of the main body 2 (the direction from the front side to the back side) is configured to be at least 8.0 mm even in the narrowest region. The sizes and shapes of the button switches 6R and 6L are preferably configured such that when used by a person having a large finger, the button switches 6R and 6L can be pressed effortlessly by the middle of the thumb when the finger is inserted into the wearing space FS up to the base of the finger. Note that the stated numerical range is merely an example, and may be set as appropriate in accordance with the device configuration.

In the present embodiment, the first finger placement portion 223 and the second finger placement portion 224 are constituted by concave curved surfaces, but may instead be constituted by planes, and the sizes thereof are configured such that at least one of the width in the insertion direction ID of the finger and the width in the circumferential direction of the main body 2 is at least 10.0 mm. In particular, it is preferable that the size and shape of the first finger placement portion 223 be set such that there is sufficient space for placing the thumb, which is the largest of the fingers.

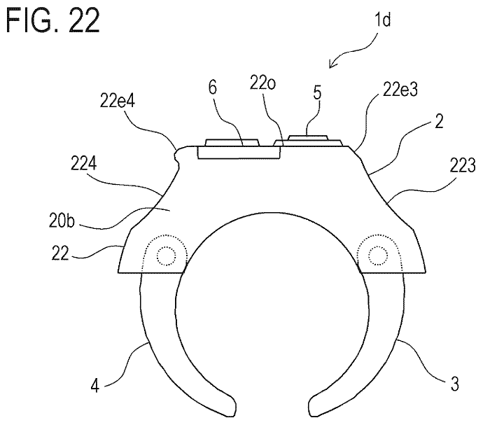

FIG. 22 is a schematic front view of a ring-shaped device 1d according to a variation. The ring-shaped device 1d includes a configuration for preventing the user from mistakenly wearing the ring-shaped device 1d with the front side and the back side thereof reversed. Specifically, the ring-shaped device 1d includes a projecting portion 22e4 as a configuration that imparts a sense of discomfort on the user when the device is worn improperly. The projecting portion 22e4 is an end portion on the back side, in the circumferential direction of the main body 2, of an operated surface 22o in which the touch sensor 5 and the button switches 6R and 6L are arranged, and is provided between an operated surface 22o and the second finger placement portion 224. The end portion of the front side of the operated surface 22o, i.e., on the opposite side, between the operated surface 22o and the first finger placement portion 223, is a flat portion 22e3. In other words, the end portion on the back side and the end portion on the front side of the operated surface 22o are configured having an asymmetrical shape.

When the front side and the back side of the ring-shaped device 1d are reversed, the thumb is placed on the second finger placement portion 224, and during operations, the thumb moves back and forth between the second finger placement portion 224 and the operated surface. Accordingly, providing the projecting portion 22e, which has a shape that inhibits the thumb from moving back and forth as described above, between the second finger placement portion 224 and the operated surface prevents the thumb from moving smoothly when the device is worn normally, which in turn makes it possible to impart a sense of discomfort on the user. This causes the user to recognize that the device is in an incorrect wearing state.

Note that the configuration that imparts a sense of discomfort on the user when the device is worn improperly is not limited to the projecting portion 22e described above. For example, a sense of discomfort may be imparted on the user by using different shapes for the first finger placement portion 223 and the second finger placement portion 224. For example, configuring the first finger placement portion 223 having a concave shape and the second finger placement portion 224 having a flat shape, the placement of the thumb, which would be stable if the device was worn properly, does not fit well and imparts a sense of discomfort on the user, which causes the user to recognize that the device is being worn improperly.

It is also conceivable that the user will wish to use the device in a wearing state in which the button switches 6R and 6L are on the front side and the touch sensor 5 is on the back side. In other words, there may be a significant number of users who deliberately wear the device with the front side and the back side reversed. In such a case, to meet the needs of such users, the control portion 10 may be configured to perform processing such that inputs to the touch sensor 5 and the button switches 6R and 6L produce input signals that are inverted vertically and horizontally.

### Arrangement of Operated Portion in Circumferential Direction

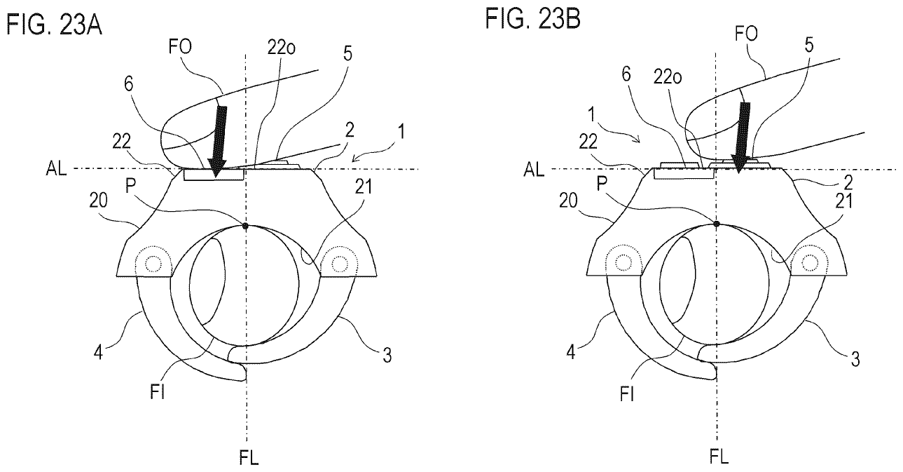

The relative arrangements of the touch sensor 5 and the button switches 6R and 6L with respect to the position where the finger makes contact on the inner surface 21 of the outer casing 20 of the main body 2 in the ring-shaped device 1 according to the present embodiment will be described with reference to FIGS. 23A to 25B.

FIG. 23A is a schematic front view of the ring-shaped device 1 according to the present embodiment, illustrating a state where the user is pressing the button switches 6R and 6L with their finger FO. FIG. 23B is a schematic front view of the ring-shaped device 1 according to the present embodiment, illustrating a state where the user is pressing the touch sensor 5 with their finger FO.

As illustrated in FIG. 23A and the like, when the ring-shaped device 1 is viewed in the insertion direction ID in which the finger is inserted into the wearing space FS, an imaginary line along the operated surface 22o (the surface where the touch sensor 5 and the button switches 6R and 6L are aligned in the circumferential direction of the main body 2), of the outer surface 22 of the outer casing 20 of the main body 2, is taken as AL. In addition, an imaginary line (imaginary reference line) that passes through a deepest part P on the inner surface 21 of the outer casing 20 of the main body 2 and is orthogonal to the imaginary line AL is taken as FL. In the ring-shaped device 1 according to the present embodiment, when viewed in the finger insertion direction ID, the touch sensor 5 and the button switches 6R and 6L arranged in the circumferential direction of the main body 2 are arranged on opposite sides of the imaginary line FL (symmetrically relative to the imaginary line FL in the circumferential direction). In other words, the touch sensor 5 is located on the front side (one side; a first side) of the main body 2 with respect to the imaginary line FL, and the button switches 6R and 6L are located on the back side (another side; a second side) of the main body 2 with respect to the imaginary line FL.

The deepest part P of the inner surface 21 for determining the imaginary line FL may be defined as a position where a finger FI inserted into the wearing space FS will always contact the inner surface 21. Alternatively, an imaginary line passing through the reference center F2C of the finger inserted into the wearing space FS and orthogonal to the imaginary line AL may be taken as the imaginary line FL. Alternatively, the deepest part P may be defined at a position within the region of the inner surface 21, located opposite the region where the first arm portion 3 and the second arm portion 4 overlap, relative to the reference center F2C of the finger inserted into the wearing space FS.

In the ring-shaped device 1 according to the present embodiment, the touch sensor 5 serving as the first operated portion and the button switches 6R and 6L serving as the second operated portion are arranged in the circumferential direction of the main body 2. Accordingly, the force that the touch sensor 5 receives due to a pressing operation by the finger FO can include a component that generates moment on the main body 2 with the contact region of the finger FI and the inner surface 21 including the deepest part P as the base point. Similarly, the force that the button switches 6R and 6L receive due to a pressing operation by the finger FO can include a component that generates moment on the main body 2 with the contact region of the finger FI and the inner surface 21 including the deepest part P as the base point. Such moment can inevitably occur due to the layout in which the touch sensor 5 and the button switches 6R and 6L are arranged in the circumferential direction of the main body 2. However, arranging the touch sensor 5 and the button switches 6R and 6L, which are positioned close to each other in the circumferential direction of the main body 2, on opposite sides of the imaginary line FL makes it possible to minimize the magnitude of the generated moment.

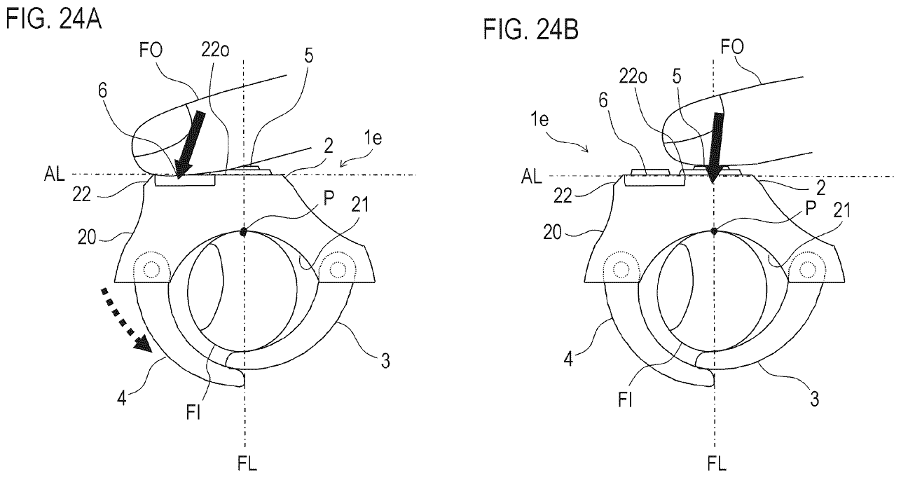

FIG. 24A is a schematic front view of a ring-shaped device 1e according to Comparative Example 3, illustrating a state where the user is pressing the button switches 6R and 6L with their finger FO. FIG. 24B is a schematic front view of the ring-shaped device 1e according to Comparative Example 3, illustrating a state where the user is pressing the touch sensor 5 with their finger FO.

As illustrated in FIGS. 24A and 24B, the ring-shaped device 1e according to Comparative Example 3 is configured with the touch sensor 5 and the button switches 6R and 6L arranged such that the touch sensor 5 overlaps the imaginary line FL when viewed in the finger insertion direction ID. In other words, the touch sensor 5 and the button switches 6R and 6L arranged in the circumferential direction of the main body 2 are arranged closer to the back side in the circumferential direction of the main body 2 (shifted toward the back side relative to the imaginary line FL). Such a configuration makes it possible to reduce the magnitude of the moment described above when the touch sensor 5 is pressed, as illustrated in FIG. 24B.

However, as illustrated in FIG. 24A, the magnitude of the generated moment cannot be suppressed when the button switches 6R and 6L are pressed, and a force that moves the main body 2 toward the back side in the circumferential direction may act on the main body 2. This may cause the ring-shaped device 1e to rotate relative to the finger FI inserted into the wearing space FS, destabilizing the wearing state of the ring-shaped device 1e relative to the finger FI.

With the ring-shaped device 1e according to Comparative Example 3, the button switches 6R and 6L are distanced from the finger FO, toward the back side in the circumferential direction. Due to the layout in which the finger FO approaches the button switches 6R and 6L from the front side toward the back side in the circumferential direction, the direction in which the compressive force of the finger FO acts when pressing the button switches 6R and 6L approaches the direction from the front side toward the back side in the circumferential direction. As a result, the magnitude of the stated moment generated in the main body 2 increases, making it more likely that a force that rotates the ring-shaped device 1e relative to the finger FI inserted into the wearing space FS will arise.

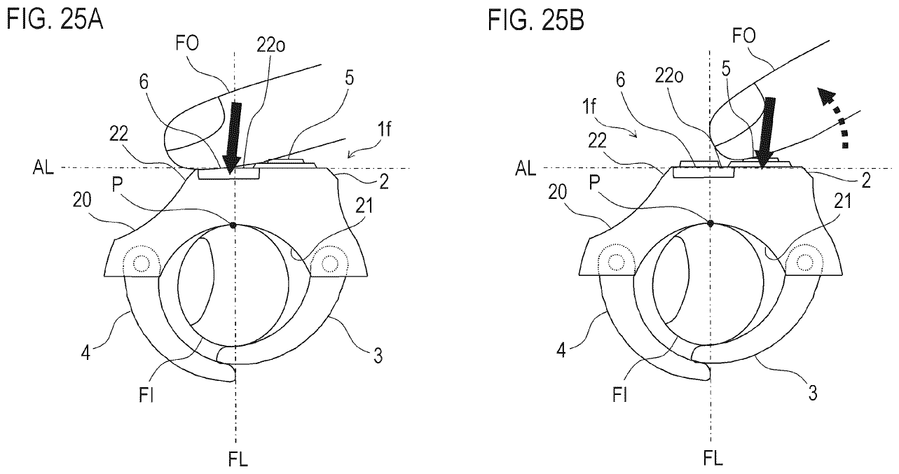

FIG. 25A is a schematic front view of a ring-shaped device 1f according to Comparative Example 4, illustrating a state where the user is pressing the button switches 6R and 6L with their finger FO. FIG. 25B is a schematic front view of the ring-shaped device 1f according to Comparative Example 4, illustrating a state where the user is pressing the touch sensor 5 with their finger FO.

As illustrated in FIGS. 25A and 25B, the ring-shaped device 1f according to Comparative Example 4 is configured with the touch sensor 5 and the button switches 6R and 6L arranged such that the button switches 6R and 6L overlap the imaginary line FL when viewed in the finger insertion direction ID. In other words, the touch sensor 5 and the button switches 6R and 6L arranged in the circumferential direction of the main body 2 are arranged closer to the front side in the circumferential direction of the main body 2 (shifted toward the front side relative to the imaginary line FL).

As described above, particularly when the finger FO is the thumb, the finger FO is in a posture where the finger FO approaches the touch sensor 5 and the button switches 6R and 6L from the front side toward the back side in the circumferential direction of the main body 2. Accordingly, the direction in which the compressive force of the finger FO acts tends to include an angle from the front side toward the back side, and the magnitude of the generated moment can therefore be suppressed regardless of whether the touch sensor 5 or the button switches 6R and 6L are pressed.

However, as illustrated in FIG. 25B, when pressing the button switches 6R and 6L arranged closer to the front side of the main body 2, it is difficult to press the button switches 6R and 6L without increasing the angle of the finger FO, especially when the finger FO is the thumb, making the posture during the pressing action awkward. This can destabilize the wearing state of the ring-shaped device 1f relative to the finger FI, which in turn can lead to erroneous operations.

Unlike the foregoing Comparative Examples 3 and 4, according to the ring-shaped device 1 of the present embodiment, the wearing state of the ring-shaped device 1 relative to the finger FI can be stabilized, and a stable usability can also be achieved without putting the finger FO in an unnatural position during pressing operations.

Although the present embodiment describes the second boundary identification rib 26 as a single rib extending continuously in the circumferential direction of the finger, the configuration is not limited thereto. For example, the configuration may be such that ribs divided in the circumferential direction, i.e., a plurality of ribs each extending in the circumferential direction, are arranged sequentially in the circumferential direction. Alternatively, the configuration may be such that a plurality of protrusions are arranged sequentially in the circumferential direction.

In addition, although the present embodiment describes the first boundary identification rib 25 as a single rib formed in a continuous annular shape, the configuration is not limited thereto. For example, the rib may have a C-shaped profile where the circle is partially interrupted, rather than a completely closed ring shape. Alternatively, the configuration may be such that, for example, a plurality of ribs each extending on an arc are arranged sequentially in a ring shape. Alternatively, the configuration may be such that a plurality of protrusions are arranged sequentially in a ring shape. The ring shape is not limited to a perfectly circular as in the present embodiment, and may be an elliptical shape. Alternatively, the shape may be polygonal rather than circular.

### Embodiment 2

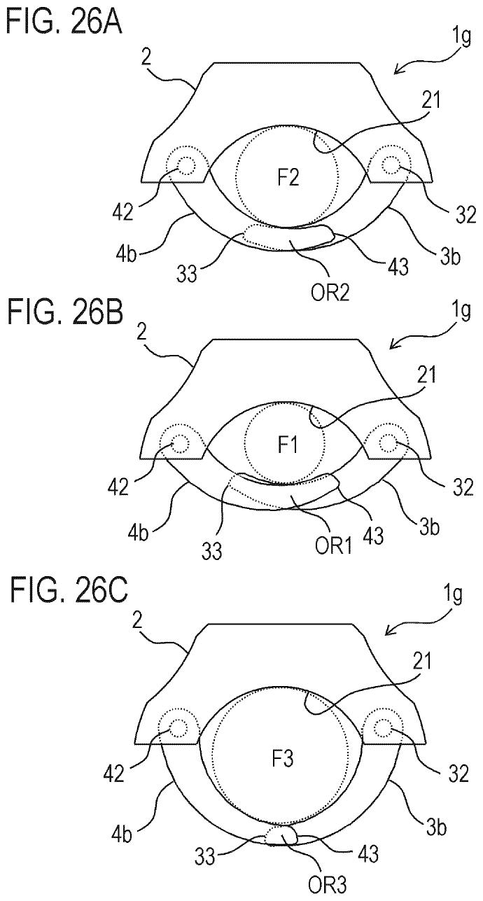

A ring-shaped device 1g according to Embodiment 2 of the present disclosure will be described with reference to FIGS. 26A to 28. Configurations of Embodiment 2 that are different from those of Embodiment 1 will be described here. Configurations of Embodiment 2 that are the same as those of Embodiment 1 will be given the same reference signs, and descriptions thereof will be omitted.

In the present embodiment, the first arm portion 3b closest to the inner surface 21 of the main body 2 and the second arm portion 4b closest to the inner surface 21 have regions that overlap when viewed in the direction of the rotation axis line 32x of the first arm portion 3b or the rotation axis line 42x of the second arm portion 4b.

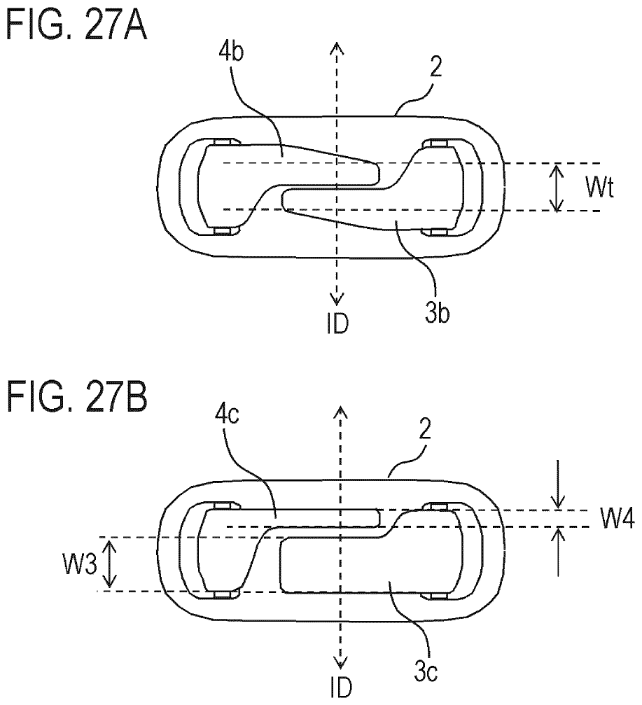

As illustrated in FIGS. 26A to 27A, the ring-shaped device 1g according to the present embodiment is arranged such that at least the tip sides of the first arm portion 3b and the second arm portion 4b are shifted from each other in the insertion direction ID. In other words, the wearing state is one in which both the first arm portion 3b and the second arm portion 4b contact the finger F. As illustrated in FIGS. 26A to 26C, the region where one arm portion overlaps the other arm portion when viewed in a direction along the insertion direction ID or the rotation axis lines 32x and 42x becomes gradually larger in the order of the regions OR3, OR2, and OR1, from the finger F3 to the finger F1.

Arranging the first arm portion 3b and the second arm portion 4b so as to alternate along the insertion direction ID in this manner reduces the size of the external shape of the ring-shaped device 1g in the direction orthogonal to the insertion direction ID, as compared to that of the ring-shaped device 1 in Embodiment 1, which improves the ease of gripping when the device is worn on the finger F.

As illustrated in FIG. 27A, the first arm portion 3b and the second arm portion 4b may be configured having shapes that are generally symmetrical in the insertion direction ID. Furthermore, as illustrated in FIG. 27A, the first arm portion 3b and the second arm portion 4b are configured such that the widths in the insertion direction ID gradually narrow with proximity to the corresponding tips. According to this configuration, for example, in the third wearing state illustrated in FIG. 4C, situations where the grip of the finger is inhibited by the first arm portion 3b and the second arm portion 4b are suppressed.

Note that as illustrated in FIG. 27A, a distance Wt from an outer end of the tip surface of the first arm portion 3b to an outer end of the tip surface of the second arm portion 4b in the insertion direction ID is preferably not more than 20 mm, or not more than the width of the main body 2 in the insertion direction ID. More preferably, the distance Wt being not more than 8 mm is more suitable for accommodating the first arm portion 3b and the second arm portion 4b between the first and second joints of the finger F.

In addition, as illustrated in FIG. 27B, a first arm portion 3c and a second arm portion 4c may be given different size widths in the insertion direction ID. In other words, the width W3 of the tip side part of the first arm portion 3c in the insertion direction ID is configured to be greater than the width W4 of the tip side part of the second arm portion 4c in the insertion direction ID. For example, the width may be set according to the difference in magnitude between the biasing force of the torsion coil spring 32s and the biasing force of the torsion coil spring 42s such that the force exerted by the first arm portion 3c on the finger F and the force exerted by the second arm portion 4c on the finger F are uniform.

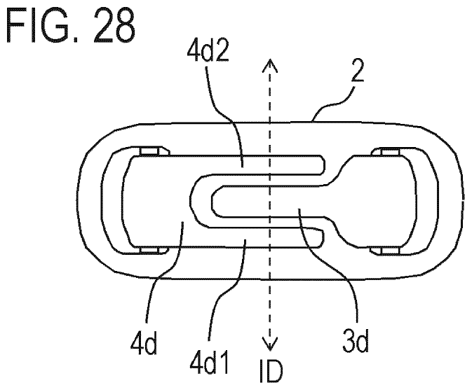

As illustrated in FIG. 28, a first arm portion 3d and a second arm portion 4d may be configured to be arranged in an interlocking manner in the insertion direction ID, in a comb-tooth shape. In other words, the second arm portion 4d has a first one-side arm portion 4d1 and a second one-side arm portion 4d2, and the first arm portion 3d is configured to be arranged between the first one-side arm portion 4d1 and the second one-side arm portion 4d2 in the insertion direction ID. The combined configuration of the first arm portion 3d and the second arm portion 4d is symmetrical with respect to the insertion direction ID, and the finger F can be inserted into the wearing space FS in the same manner from either the left or right side in the insertion direction ID. In other words, it is not necessary to pay attention to the insertion direction when putting the ring-shaped device 1g on the finger F, which makes it possible to improve the wearability.

The configurations of the respective embodiments described above can be combined with each other to the greatest extent possible.

The present disclosure is not limited to the above embodiments, and various changes and modifications can be made within the spirit and scope of the present disclosure. Therefore, to apprise the public of the scope of the present invention, the following aspects are made.

According to the present disclosure, a user of a ring-shaped device including a vibrating element can more efficiently and effectively sense vibrations.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

What is claimed is:

1. A ring-shaped device worn on a finger of a user, the ring-shaped device comprising:
an annular body surrounding a wearing space;
a vibrating element, provided inside of the annular body, which vibrates along a vibration axis line; and
a control portion that controls the vibrating element,
wherein an imaginary line passing through the vibrating element along the vibration axis line of the vibrating element passes through the wearing space.

2. The ring-shaped device according to claim 1,
wherein the imaginary line passes through an inner surface of the annular body that forms the wearing space and an outer surface of the annular body opposite from the inner surface.

3. A ring-shaped device worn on a finger of a user, the ring-shaped device comprising:
an annular body surrounding a wearing space;
a vibrating element, provided inside of the annular body, which vibrates along a vibration axis line; and
a control portion that controls the vibrating element,
wherein an imaginary line passing through the vibrating element along the vibration axis line of the vibrating element passes through the wearing space,
one end of the vibrating element in a direction in which the vibration axis line of the vibrating element extends is on a side close to an inner surface of the annular body that forms the wearing space, and
another end of the vibrating element in the direction in which the vibration axis line extends is on a side close to an outer surface of the annular body opposite from the inner surface.

4. The ring-shaped device according to claim 1,
wherein the direction in which the vibration axis line extends is a direction intersecting with an insertion direction in which the finger is inserted into the wearing space.

5. The ring-shaped device according to claim 1,
wherein the vibrating element is provided, inside of the annular body, closer to the inner surface of the annular body that forms the wearing space than the outer surface opposite from the inner surface.

6. The ring-shaped device according to claim 1,
wherein a longitudinal direction of the vibrating element is aligned along the insertion direction in which the finger is inserted into the wearing space.

7. The ring-shaped device according to claim 1,
wherein the annular body has, on the outer surface opposite from the inner surface that forms the wearing space, a contacted potion contacted by a finger different from the finger inserted into the wearing space, and
the imaginary line passing through the vibrating element along the vibration axis line passes through the contacted portion.

8. The ring-shaped device according to claim 7,
wherein the annular body is provided with an operation member in a part of the contacted portion.

9. The ring-shaped device according to claim 8,
wherein the imaginary line does not pass through the operation member.

10. The ring-shaped device according to claim 7,
wherein the vibrating element is provided, inside of the annular body, closer to the outer surface than the inner surface.

11. The ring-shaped device according to claim 1, further comprising:
a geomagnetic sensor provided inside of the annular body,
wherein the imaginary line passing through the vibrating element along the vibration axis line does not pass through the geomagnetic sensor.

12. The ring-shaped device according to claim 11,
wherein the vibrating element is separated from a board on which the geomagnetic sensor is mounted.

13. The ring-shaped device according to claim 11,
wherein in a case of being viewed in an insertion direction in which the finger is inserted into the wearing space,
the vibrating element and the geomagnetic sensor are separated such that an angle formed by the vibrating element and the geomagnetic sensor in a circumferential direction around a reference center of the wearing space is at least no less than 60 degrees and is preferably no less than 90 degrees.

14. The ring-shaped device according to claim 1, further comprising:
an inertial sensor provided inside of the annular body,
wherein the imaginary line passing through the vibrating element along the vibration axis line does not pass through the inertial sensor.

15. The ring-shaped device according to claim 14,
wherein the vibrating element is separated from a board on which the inertial sensor is mounted.

16. The ring-shaped device according to claim 14,
wherein in a case of being viewed in an insertion direction in which the finger is inserted into the wearing space,
the vibrating element and the inertial sensor are separated such that an angle formed by the vibrating element and the inertial sensor in a circumferential direction around a reference center of the wearing space is at least no less than 60 degrees and is preferably no less than 90 degrees.

17. The ring-shaped device according to claim 1, further comprising:
a control board, provided inside of the annular body, on which the control portion is mounted,
wherein the imaginary line passing through the vibrating element along the vibration axis line does not pass through the control board.

18. The ring-shaped device according to claim 17,
wherein the vibrating element is separated from the control board.

19. The ring-shaped device according to claim 1, further comprising:
a wireless antenna provided inside of the annular body,
wherein the imaginary line passing through the vibrating element along the vibration axis line does not pass through the wireless antenna.

20. The ring-shaped device according to claim 19,
wherein in a case of being viewed in the insertion direction in which the finger is inserted into the wearing space,
the vibrating element and the wireless antenna are separated such that an angle formed by the vibrating element and the wireless antenna in a circumferential direction around a reference center of the wearing space is at least no less than 30 degrees and is preferably no less than 90 degrees.

21. The ring-shaped device according to claim 19, further comprising:
a lithium-ion battery provided inside of the annular body,
wherein a gap is provided between the wireless antenna and the lithium-ion battery, and
the gap provides a space for ensuring a sensitivity of the wireless antenna and a space for allowing the lithium-ion battery to expand.

22. The ring-shaped device according to claim 1,
wherein the annular body includes:
a main body;
a first arm portion connected to one end side of the main body; and
a second arm portion connected to another end side of the main body,
the vibrating element is provided inside of the main body, and
the imaginary line passing through the vibrating element along the vibration axis line passes through at least one of the first arm portion and the second arm portion.
